(19) United States
(12) Patent Application Publication
(10) Pub. No.: US 2026/0017828 A1
(43) Pub. Date: Jan. 15, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Masafumi TAKIMOTO, Kanagawa (JP); Yusuke BABA, Tokyo (JP)

(21) Appl. No.: 19/263,602

(22) Filed: Jul. 9, 2025

(30) Foreign Application Priority Data
Jul. 10, 2024 (JP) 2024-111288
Jan. 31, 2025 (JP) 2025-014953

(51) Int. Cl. G06T 7/80; G06T 7/00; G06T 17/00

(52) U.S. Cl. CPC G06T 7/80; G06T 7/97; G06T 17/00

(57) ABSTRACT

An information processing apparatus includes: an obtainment unit configured to obtain a captured image obtained by each of multiple image capturing apparatuses; a detection unit configured to detect a position of a predetermined part in the object from the captured image of each of the multiple image capturing apparatuses; an estimation unit configured to estimate a camera parameter indicating a position and an orientation of each of the multiple image capturing apparatuses by using the detected position of the predetermined part; an update unit configured to update the camera parameter of each of the multiple image capturing apparatuses by using the estimated camera parameter as an initial value; and a determination unit configured to determine the camera parameter of each of the multiple image capturing apparatuses based on a result of performing three-dimensional reconstruction of the object based on the updated camera parameter.

### BACKGROUND

### Field of the Technology

The present disclosure relates to processing based on a captured image.

### Description of the Related Art

There has been a method of estimating a three-dimensional shape of an object. The estimated three-dimensional shape is used to, for example, generate a virtual viewpoint image, which is a two-dimensional image of the object viewed from a virtual viewpoint. Conventionally, a method of estimating the three-dimensional shape of the object in a geometric perspective by a multi-view stereo method or a shape-from-X method typified by a visual hull has been common. It is possible to say about the conventional methods that the methods have been proposed as a solution for an inverse problem of an ill-posed problem by mathematically formalizing a projection process from three dimensions to two dimensions.

In order to estimate a high quality three-dimensional shape by the conventional methods, many cameras have been required since many captured images are required as input images, and the cameras have been required to be adjusted precisely. Additionally, in the visual hull, it is impossible to deal with a recessed shape, and in a technique related to the multi-view stereo method, it is impossible to pursue accuracy in a case where a texture that fails matching of images in stereovision is inputted. Thus, all the conventional methods have the shape, the texture, and so on that make the estimation of the three-dimensional shape difficult.

Therefore, along with the development of a deep learning technique, there has been proposed a method of obtaining a three-dimensional reconstruction result, which is used to output an image of the object viewed from a desired viewpoint, from the input images.

Although it is limited to a person, a method of utilizing a model learned in advance by deep learning to estimate a three-dimensional shape of a learned target included in an inputted two-dimensional image is described in Saito, S, Huang, Z, Natsume, R, Morishima, S, Li, H, Kanazawa, A. Pifu: Pixel-aligned implicit function for high-resolution clothed human digitization. In: 2019 IEEE/CVF International Conference on Computer Vision (ICCV). 2019. (Non-Patent Literature 1). However, the method in Non-Patent Literature 1 assumes that an image of an object that is inputted to the model is captured by a camera in a position at a distance similar to a distance between the camera and the object in a case of the learning.

A method of simultaneously optimizing an orientation of a camera and a radiance field is proposed in Chen-Hsuan Lin, Wei-Chiu Ma, Antonio Torralba, and Simon Lucey. BARF: Bundle-Adjusting Neural Radiance Fields. In: 2021 IEEE/CVF International Conference on Computer Vision (ICCV). 2021. (Non-Patent Literature 2). However, in the method of Non-Patent Literature 2, in a case where three-dimensional reconstruction is performed in a scene where a moving object exists and changes, synchronized image capturing by a great number of cameras is required.

A method called a NeRF is described in Ben Mildenhall, Pratul P Srinivasan, Matthew Tancik, Jonathan T Barron, Ravi Ramamoorthi, and Ren Ng. Nerf: Representing scenes as neural radiance fields for view synthesis. In European conference on computer vision, pages 405-421. Springer, 2020. (Non-Patent Literature 3). According to Non-Patent Literature 3, a scene is expressed by utilizing a completely connected deep network. According to Non-Patent Literature 3, it is possible to reproduce the reconstruction of a three-dimensional shape of an object from captured images obtained by the image capturing by a sparse set of cameras and also the rendering to obtain a two-dimensional image of the object viewed from a designated viewpoint.

### SUMMARY

An information processing apparatus of the present disclosure includes: an obtainment unit configured to obtain a captured image obtained by each of multiple image capturing apparatuses by capturing an object; a detection unit configured to detect a position of a predetermined part in the object from the captured image obtained by each of the multiple image capturing apparatuses; an estimation unit configured to estimate a camera parameter indicating a position and an orientation of each of the multiple image capturing apparatuses by using the detected position of the predetermined part; an update unit configured to update the camera parameter of each of the multiple image capturing apparatuses by using the estimated camera parameter as an initial value; and a determination unit configured to determine the camera parameter of each of the multiple image capturing apparatuses based on a result of performing three-dimensional reconstruction of the object based on the updated camera parameter.

Features of the present disclosure will become apparent from the following description of embodiments with reference to the attached drawings. The following description of embodiments are described by way of example.

### BRIEF DESCRIPTION OF THE DRAWINGS

FIGS. 1A to 1C are diagrams describing an image capturing environment;

FIG. 2 is a diagram illustrating arrangement of cameras having no common visual fields;

FIG. 3 is a diagram illustrating an example of a system configuration;

FIGS. 4A and 4B are flowcharts describing processing of determining a camera parameter;

FIG. 5 is a diagram showing the relationship of FIG. 5A and FIG. 5B.

FIGS. 5A and 5B are diagrams describing a flow of the processing of determining the camera parameter;

FIG. 6 is a diagram illustrating an example of skeleton information;

FIGS. 7A and 7B are diagrams describing an image capturing environment;

FIGS. 8A and 8B are flowcharts describing processing of determining the camera parameter.

FIGS. 9A and 9B are diagrams describing a mask;

FIG. 10 is a diagram showing the relationship of FIG. 10A, FIG. 10B and FIG. 10C.

FIGS. 10A, 10B and 10C are diagrams describing a flow of the processing of determining the camera parameter;

FIGS. 11A to 11D are diagrams illustrating an example of an image outputted from a three-dimensional reconstruction result;

FIG. 12 is a diagram illustrating an example of a system configuration;

FIGS. 13A and 13B are flowcharts describing processing of determining the camera parameter;

FIG. 14 is a diagram describing image capturing time of multiple cameras;

FIGS. 15A and 15B are diagrams illustrating a track of an estimated joint;

FIGS. 16A and 16B are diagrams describing displacement of the joint;

FIG. 17 is a diagram describing an image capturing environment;

FIG. 18 is a flowchart describing processing of determining the camera parameter; and

FIG. 19 is a diagram describing an image capturing environment.

### DESCRIPTION OF THE EMBODIMENTS

In the method of Non-Patent Literature 3 described above, it is impossible to appropriately obtain a three-dimensional reconstruction result of an object in a case where a position and an orientation of a camera are unknown. Therefore, it is necessary to execute camera calibration in advance to obtain a camera parameter.

A method of obtaining an orientation of an unknown camera in a learning process of a NeRF even with about four to six cameras is described in Levy, Axel and Matthews, Mark and Sela, Matan and Wetzstein, Gordon and Lagun, Dmitry, MELON: NeRF with Unposed Image s Using Equivalence Class Estimation, arXiv: preprint, 2023. (Non-Patent Literature 4). In the method of Non-Patent Literature 4, it is necessary to install the cameras under the conditions that all the cameras face the center of a scene from an already-known distance.

Thus, in a case where the positions of the cameras are unknown and the three-dimensional reconstruction is performed by deep learning from images captured by a small number of cameras, it is difficult to obtain an accurate three-dimensional reconstruction result without appropriate camera calibration. Therefore, a user needs to perform the camera calibration including preparing a fixed pattern and capturing images, and it is laborious for the user.

Embodiments according to the technique of the present disclosure are described below with reference to the drawings. The following embodiments are not intended to limit the technique of the present disclosure, and not all the combinations of the characteristics described in the present embodiments are necessarily required for the means for solving the problems of the technique of the present disclosure. Configurations of the embodiments may be modified or changed as needed depending on a specification, use conditions, a use environment, and the like of an apparatus to which the technique of the present disclosure is applied. Additionally, in the following embodiments, the same reference numerals are provided to the same or similar configurations, and duplicated descriptions are omitted.

### First Embodiment

In the present embodiment, a method of capturing images of a person by a small number of image capturing apparatuses in synchronization in an image capturing environment in which the single person exists and determining the camera parameter while performing the three-dimensional reconstruction with input of each video (image) obtained by the synchronized image capturing is described.

The three-dimensional reconstruction is calculation processing to obtain the three-dimensional reconstruction result.

The three-dimensional reconstruction result is a model such as the NeRF that cannot be directly read by an external CG tool but holds a learning result of a three-dimensional shape of a target object as a weight of an MLP, for example. The NeRF is a model that makes it possible to take out an image in a case of observing the target object from an arbitrary viewpoint by inputting information of the viewpoint. It is assumed that the three-dimensional reconstruction result also includes a model that outputs a two-dimensional image viewed from an arbitrary viewpoint by inputting the viewpoint. Some of the above-described model may be a model that is unclear whether the model actually holds a parameter representing the three-dimensional shape; however, since the model performs similar output as the model including the learning result of the three-dimensional shape as the weight, it is assumed that such a model is also included as the three-dimensional reconstruction result. Alternatively, the three-dimensional reconstruction result may be an image (three-dimensional shape data) itself in a format that makes it possible to browse the three-dimensional shape of the target object by reading with an external CG tool, such as a voxel or mesh data format. Hereinafter, in the present embodiment, it is described under the assumption that the three-dimensional reconstruction result is a model like the NeRF. Additionally, in the present embodiment, it is described under the assumption that the target object of the three-dimensional reconstruction is the single person in the image capturing environment.

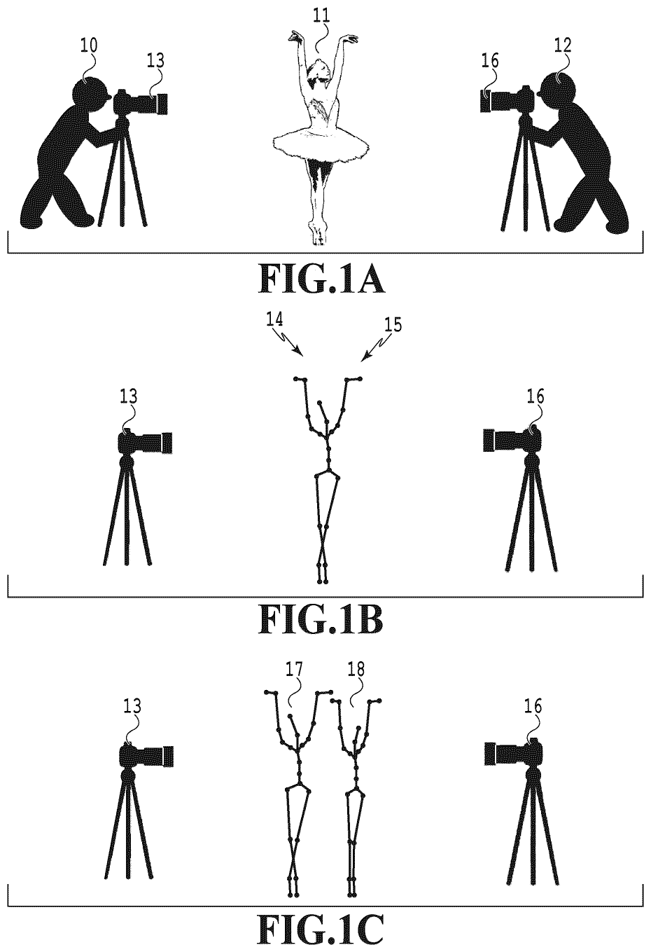

FIG. 1A is a diagram describing the image capturing environment of the present embodiment. The image capturing environment expected in the present embodiment is a place where the single person is performing dance, ballet, gymnastics, or the like. For example, a target person 11, which is the target object as a learning target of the three-dimensional shape in the three-dimensional reconstruction, is a child attending a recital of ballet, rhythmic gymnastics, material arts performance, or the like. In addition, an operation in a case where family members 10 and 12 of the child capture the images for recording is expected. In this case, the number of cameras that the family members 10 and 12 can prepare to capture the images is considered to be about two or three as cameras 13 and 16 in FIG. 1A. For this reason, in the image capturing environment as illustrated in FIG. 1A, it is impossible to execute the three-dimensional reconstruction by a method based on the captured images obtained by capturing the images with an enormous number of cameras like a case of professional three-dimensional reconstruction. Therefore, in the present embodiment, a technique that makes it possible to perform the three-dimensional reconstruction of the performance itself of the person based on a video obtained by the synchronized image capturing by the small number of, about two to three, cameras and to output a video rendered from various viewpoints is provided.

Comparing with a case of executing the three-dimensional reconstruction with a sufficient number of cameras, it is more difficult for the technique required to execute the three-dimensional reconstruction by using the video obtained by capturing the images of the person with the small number of cameras, about two to three, to perform sufficient three-dimensional reconstruction from only the data of the captured images. Therefore, in the present embodiment, the three-dimensional reconstruction is performed by the deep learning while utilizing previous knowledge about the target person 11. In a method of performing the three-dimensional reconstruction from a small number of image capturing viewpoints while utilizing the previous knowledge, the three-dimensional reconstruction of an image-captured region is performed as faithful as possible to an observation region. On the other hand, the three-dimensional reconstruction of a region that is not image-captured is executed by inference using the previous knowledge, information of another frame, or the like. Therefore, in order to obtain a good three-dimensional reconstruction result, it is desirable for the cameras to capture the images with less duplicate information so as to be able to take many pieces of information about the target person 11 even with the small number of image capturing viewpoints. That is, an installation environment of the cameras favorable for the three-dimensional reconstruction is an installation environment in which each camera captures the images in a position and an orientation having less common visual fields between the cameras.

In FIG. 1A, the cameras 13 and 16 capture the images from opposite sides of the target person 11. Therefore, the camera 16 captures the image of a left side of the target person 11, while the camera 13 captures the image of a right side of the target person 11. Thus, in a case where the number of the cameras is two, the cameras are arranged such that there are only a few common visual fields between the cameras 13 and 16.

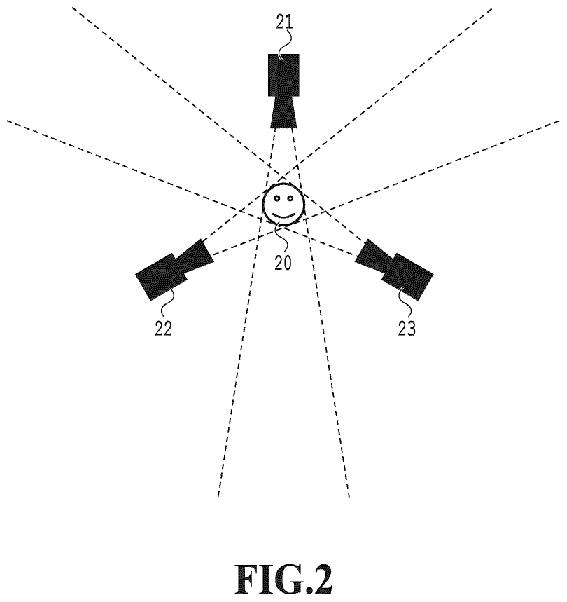

FIG. 2 is a diagram viewing the image capturing environment from above and is a diagram illustrating a situation where the images of a target person 20 are captured by three cameras. In FIG. 2, an example in which cameras 21, 22, and 23 are arranged to surround the entire circumference of the target person 20 so as to prevent a region of the target person 20 from including a region in which no images are captured is illustrated. Also in a case where the number of the cameras is three, it can be seen that there are only a few common visual fields by installing the cameras favorably for the three-dimensional reconstruction. Thus, in order to appropriately perform the three-dimensional reconstruction based on the images from the two or three cameras, the cameras are installed to have only a few common visual fields.

However, it is difficult to execute the camera calibration to obtain the camera parameter from the images obtained by the image capturing by the cameras in the positions and the orientations having a few common visual fields.

In the camera calibration utilizing a natural feature, a natural feature amount such as a RootSIFT feature amount is detected, and a relative positional relationship of the cameras is obtained based on a conspicuous feature point in the scene by Structure from Motion (SfM). In a case of the method, it is known that the obtainment of a corresponding point fails without the images having a certain degree of similarity. Therefore, in a case where there are only a few common visual fields between the cameras as the image capturing environment of the present embodiment, the camera calibration fails.

Alternatively, as another method of executing the camera calibration, there is a method of capturing the images of an already-known reference object and determining the camera parameter based on an image-captured specific position. As an example of the simplest already-known reference object, there is utilization of a two-dimensional flat surface, and it is general to print an already-known fixed pattern, which can be stably detected, on the two-dimensional flat surface and utilize. Specifically, the cameras as the calibration target capture the images of a chessboard that is a representative example of the fixed pattern. In addition, there is a method of executing the camera calibration by utilizing a corner point of the chessboard. In a case where the above-described camera calibration is executed in a system including multiple cameras, it is necessary to obtain the relative positional relationship between the corresponding cameras, and thus it is necessary to capture the images of the same corner point of the chessboard simultaneously. Therefore, also in this method of the camera calibration, it is necessary to capture the images to include many common visual fields between the cameras in order to obtain the appropriate camera parameter. Thus, in the installation environment of the cameras favorable for the three-dimensional reconstruction expected in the present embodiment, it is difficult to execute the general camera calibration.

In addition, the image capturing environment expected in the present embodiment is not an environment like a studio where the camera calibration can be sufficiently executed in advance but an environment in which a family captures the image of a ballet recital or the like of a child for recording. For instance, it is assumed that it is possible to execute the camera calibration by the above-described method using the chessboard. Even in this case, it is a burden for the family members 10 and 12 as a videographer to stop the performance of another performer before the image capturing and ask the others to raise a chessboard pattern for the camera calibration to be image-captured by the family members 10 and 12.

Therefore, in the present embodiment, a method that makes it possible to appropriately execute the camera calibration with no dependence on the natural feature amount or no image capturing of the fixed pattern is proposed. In the present embodiment, skeleton estimation of the target person 11 is executed from the images obtained from the corresponding cameras, and position information (skeleton information) of joints of the target person 11 obtained as a result is utilized to execute the camera calibration. This camera calibration is referred to as camera calibration 1.

### [About Error of Skeleton Information]

FIG. 1B illustrates theoretical positions of skeleton information 14 estimated from the images captured by the camera 13 and skeleton information 15 estimated from the images captured by the camera 16. Ideally, joint positions of the person estimated from the images captured by the cameras 13 and 16 in synchronization should completely match in the same coordinate system (world coordinates). Thus, it is assumed that the pieces of skeleton information 14 and 15 estimated from the images obtained by the image capturing by the cameras 13 and 16 completely match in the world coordinates. In this case, based on positional coordinates of the joints indicated by the skeleton information, it is possible to appropriately calculate the camera parameter indicating the relative positional relationship of the cameras 13 and 16 by using the assumption that different cameras are observing the same point.

FIG. 1C is a diagram illustrating actual skeleton information 17 estimated from the images captured by the camera 13 and actual skeleton information 18 estimated from the images captured by the camera 16. As illustrated in FIG. 1C, in reality, complete matching of the skeleton information estimated from the cameras 13 and 16 is extremely rare, and the positions and scales of the joints indicated by the skeleton information estimated by the cameras 13 and 16 are different. A usage pattern expected in the present embodiment is not an environment in which the positions and the orientations of the multiple cameras are determined in advance, and the image capturing with the cameras in the positions and the orientations as illustrated in FIG. 1C is determined for the first time in a testing environment. Therefore, in a case where the skeleton estimation is performed from the images obtained by the image capturing by the cameras 13 and 16 as described above, it is almost impossible to obtain the skeleton information in completely matching coordinates as exemplified in FIG. 1B.

Therefore, in the present embodiment, camera calibration 2 described later is additionally executed. According to this method, it is possible to appropriately determine the camera parameter even with the small number of image capturing viewpoints, and it is possible to execute the camera calibration with only an image-captured scene with no need to capture the image of the fixed pattern by the videographer only for the camera calibration.

### [System Configuration]

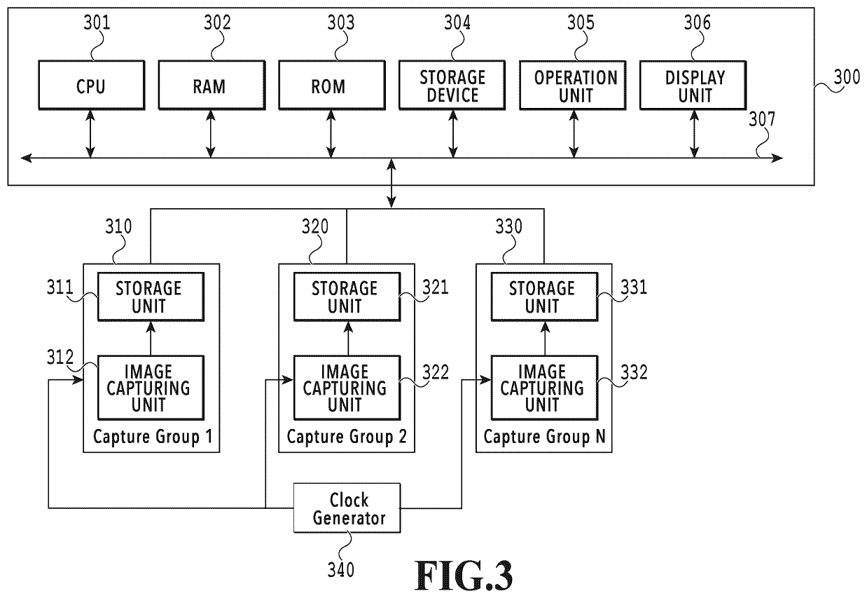

FIG. 3 is a diagram describing apparatuses included in a system according to the present embodiment and a hardware configuration of each apparatus.

The system in the present embodiment includes an information processing apparatus 300, three capture groups 310, 320, and 330, and a clock generator 340.

The information processing apparatus 300 is an apparatus that receives the corresponding captured images obtained by the image capturing by image capturing units 312, 322, and 332 of the capture groups 310, 320, and 330 in temporal synchronization and executes the camera calibration and the three-dimensional reconstruction.

As the simplest example, each of the capture groups 310, 320, and 330 is implemented by an image capturing apparatus such as a digital camera. In a case of the digital camera, each of storage units 311, 321, and 331 is a storage unit such as a memory card. The number of the capture groups 310, 320, and 330 is three; however, it is an example, and in the image capturing environment as illustrated in FIG. 1A, the two capture groups 310 and 320 are applied, for example. Hereinafter, in a case of simply mentioning a camera in the embodiment, it means a capture group.

The clock generator 340 is an apparatus that applies an image capturing time such as a time code to each of the captured images (frames) obtained by the image capturing by the corresponding image capturing units 312, 322, and 332 in the capture groups 310, 320, and 330.

The information processing apparatus 300 can perform synchronization after receiving the captured images and record the captured images with reference to the image capturing time applied to the received captured images. In addition, the information processing apparatus 300 can execute the camera calibration and the three-dimensional reconstruction by using the recorded captured images.

Note that, in FIG. 3, the clock generator 340 is illustrated such that the single apparatus is connected with all the capture groups 310, 320, and 330 with or without wire. In addition, for example, the clock generator 340 may be multiple clock generators synchronized with each other in advance. In this case, three clock generators 340 are included in the capture groups 310, 320, and 330, respectively, and it is also possible to obtain a similar effect with each clock generator 340 embedding the image capturing time into the corresponding one of the captured images.

Additionally, the image capturing by the image capturing units 312, 322, and 332 is, for example, performed with a single user providing a command of the synchronized image capturing to each of the capture groups 310, 320, and 330 via a smartphone or the like. Alternatively, as illustrated in FIG. 1A, in a case of an environment in which a single videographer can control the cameras 13 and 16 nearby, since it is possible to apply the time code and perform synchronization, it is unnecessary to strictly match the times of starting the image capturing and ending the image capturing. Therefore, the videographers who manage the capture groups 310, 320, and 330, respectively, may provide an instruction of the image capturing.

### [Hardware Configuration of Information Processing Apparatus]

The information processing apparatus 300 includes a CPU 301, a RAM 302, a ROM 303, a storage device 304, an operation unit 305, and a display unit 306.

The CPU 301 executes various types of processing by using a computer program and data stored in the RAM 302 and the ROM 303. Thus, the CPU 301 executes or controls the various types of processing to control operations of overall the information processing apparatus 300.

The RAM 302 includes an area to store the computer program and the data loaded from the ROM 303 or the storage device 304 and an area to store data received from the capture groups 310, 320, and 330. In addition, the RAM 302 includes a working area used by the CPU 301 to execute the various types of processing. Thus, the RAM 302 can provide various areas as needed.

The ROM 303 is a storage unit that stores setting data of the information processing apparatus 300, a computer program and data related to activation, a computer program and data related to a basic operation, and so on.

The storage device 304 is implemented by a hard disk drive device or the like. The storage device 304 saves an operating system (OS), a computer program to cause the CPU 301 to execute or control various types of processing performed by the information processing apparatus 300, or data. The data saved in the storage device 304 also includes data related to a DNN model that executes the three-dimensional reconstruction. The computer program and the data saved in the storage device 304 are loaded into the RAM 302 according to the control by the CPU 301 as needed and become a processing target by the CPU 301.

The operation unit 305 is a user interface such as a keyboard, a mouse, and a touch panel and can input various instructions to the CPU 301 by being operated by the user.

The display unit 306 includes a screen such as a liquid crystal screen and a touch panel screen and can display a processing result by the CPU 301 with an image, a character, and the like. Note that, the display unit 306 may be a projection device such as a projector that projects an image and a character. At least either one of the display unit 306 and the operation unit 305 may exist as another apparatus outside the information processing apparatus 300. The CPU 301 operates as a display control unit that controls displaying on the screen by the display unit 306 and an operation control unit that controls the operation unit 305.

The CPU 301, the RAM 302, the ROM 303, the storage device 304, the operation unit 305, and the display unit 306 are connected to a system bus 307. Note that, a configuration of the information processing apparatus 300 is not limited to the configuration illustrated in FIG. 3.

The information processing apparatus 300 is a computer apparatus including a set of input and output devices such as a personal computer (PC), a smartphone, and a tablet terminal apparatus. Alternatively, the information processing apparatus 300 in the present embodiment may be an information processing system including multiple information processing apparatuses. That is, it is assumed that the information processing apparatus 300 includes the information processing system.

### [About Camera Calibration and Three-Dimensional Reconstruction]

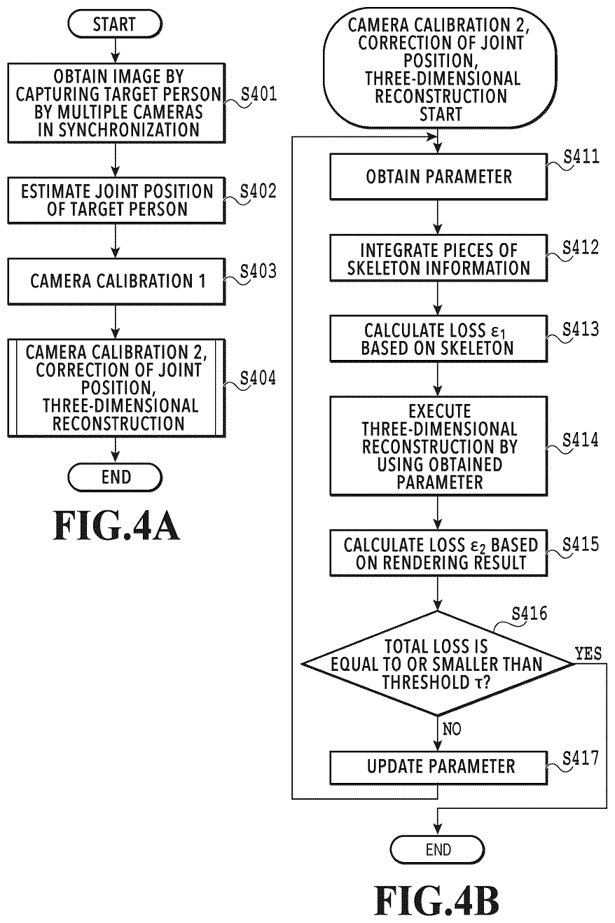

FIGS. 4A and 4B are flowcharts describing a flow of processing of the camera calibration and the three-dimensional reconstruction of the present embodiment. A series of steps illustrated in the flowcharts in FIGS. 4A and 4B is performed with the CPU 301 of the information processing apparatus 300 deploying a program code stored in the ROM 303 to the RAM 302 to execute. Additionally, a part of or all the functions of the steps in FIGS. 4A and 4B may be implemented by hardware such as an ASIC and an electronic circuit. A sign “S” in description of each processing means a step in the flowchart, and the same applies to the subsequent flowcharts.

In the flowcharts in FIGS. 4A and 4B, a case where each of a small number of, two or three, capture groups captures the images of the single person in synchronization for about a few minutes in a temporal direction (chronological order) is expected. Additionally, for the sake of simple description, in the present embodiment, an internal camera parameter of the camera is fixedly obtained in advance. Therefore, in the description of FIGS. 4A and 4B, the parameter related to the camera obtained by the camera calibration relates to an external camera parameter.

As for the description of the flowcharts in FIGS. 4A and 4B, it is described under the assumption that the two cameras 13 and 16 as the two capture groups capture the images of the target person 11 as illustrated in FIG. 1A. Although the minimum set of the number of the cameras in the present embodiment is two, the number may be three or more. Additionally, it is described under the assumption that the cameras 13 and 16 capture the images while the positions and the orientations are fixed.

In S401, the CPU 301 receives a movie (a video) including the target person 11 that is obtained with the cameras 13 and 16 capturing the images of the target person 11 in synchronization. The movie is images including multiple frames. After the image capturing starts, F frames that are the captured images continuous in the temporal direction are received.

In S402, the CPU 301 refers to the time code embedded in each of the received frames. Then, as input images, the CPU 301 obtains the frame that is obtained by the image capturing by the camera 13 and the frame to which the same time code is applied that is out of the frames obtained by the image capturing by the camera 16. The time codes having a difference within a predetermined value may be processed as the same time code.

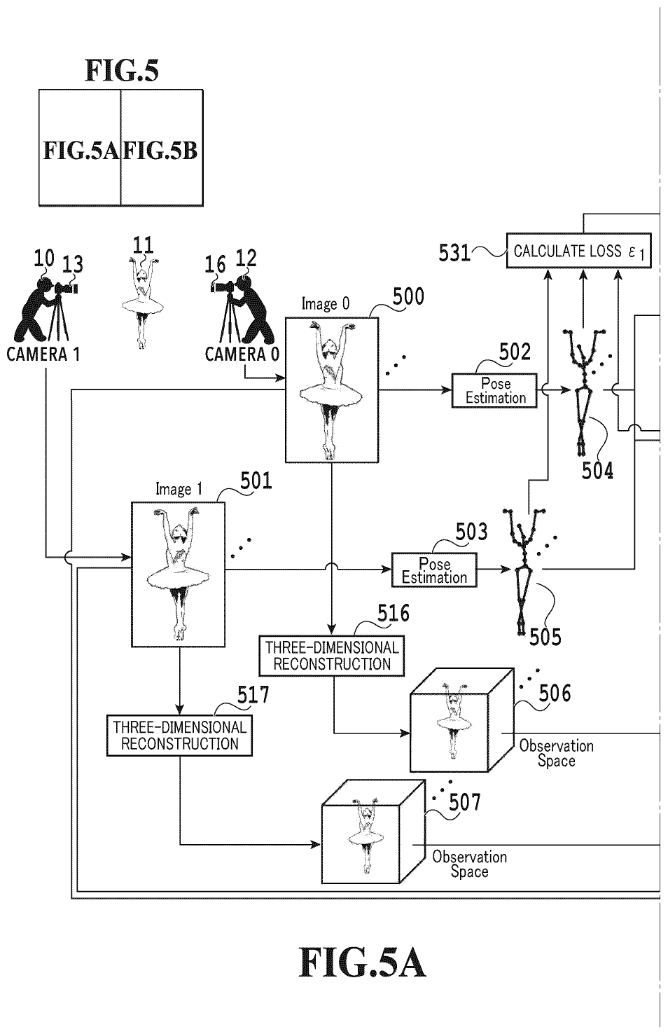

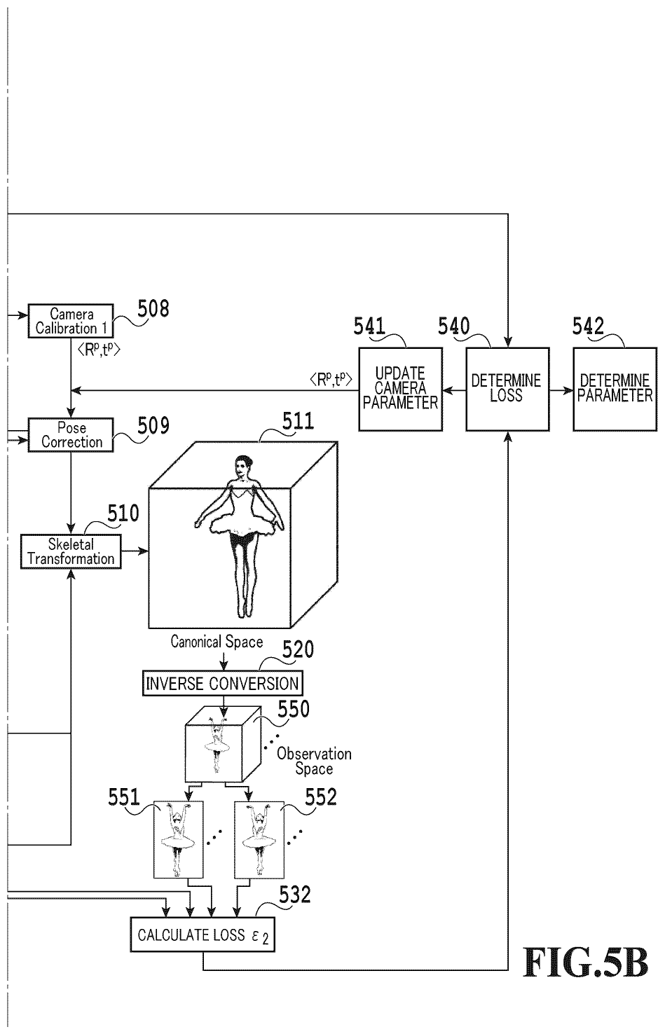

FIGS. 5A and 5B are architecture diagrams describing the processing in the flowcharts in FIGS. 4A and 4B. An input image 500 as Image 0 is an image obtained by the image capturing by the camera 16. An input image 501 as Image 1 indicates an image obtained by the image capturing by the camera 13. It is assumed that the input images 500 and 501 are the frames that are received in S401 and to which the same time code is applied in S402.

Then, in S402, posture estimation (the skeleton estimation) of the person is executed for each of the input images to which the same time code is applied. In the skeleton estimation of the human body, it is assumed that a position of each joint three-dimensional camera coordinates is estimated as a position of a part of the target person 11.

The skeleton estimation executed in S402 may be a method of directly estimating the position of each joint of the person in the three-dimensional coordinates from the input images; however, in the present embodiment, a method of detecting a position of each joint in two-dimensional coordinates in the input images is described first. In a case where it is possible to detect the position of each joint in the input images (a two-dimensional coordinate plane) with high accuracy, it is easy to convert the information of the position of each joint from the two-dimensional coordinates into the information in the three-dimensional coordinates based on a key point feature amount of the detected position of each joint in the two-dimensional coordinates.

As a method of detecting the position of each joint in the two-dimensional coordinates, for example, there is Cascaded Pyramid Network (CPN) described in Y Chen, Z. Wang, Y Peng, and Z. Zhang. Cascaded Pyramid Network for Multi-Person Pose Estimation. In CVPR, 2018. (Non-Patent Literature 5).

The method of detecting the joint position by the CPN is a method of detecting a person region by an object detection algorithm and thereafter estimating the posture related to each person region detected. In a case of using the method of estimating the position of each joint in the two-dimensional coordinates like the CPN, it is possible to calculate a likelihood related to the estimated positions of the joints. The likelihood may be calculated by any type of method. For example, with a method of obtaining a final joint position by outputting and integrating multiple likelihood maps that each output the positional coordinates of the multiple joints, it is possible to obtain the likelihood by obtaining the accumulated maximum value in a case where the likelihood maps are all overlapped at the same resolution of the input images, for example.

With the above method, the input images continuous in the temporal direction of the movie are received, and the estimation of the position of the joint in the two-dimensional coordinates is executed for each image.

Assuming that the internal camera parameter of each camera is already known and fixed and P cameras are used for the image capturing, a camera ID of each camera is described as p (0≤p<P), and a camera having the camera ID of p is described as a camera p. For example, in a case where there are two cameras (P=2), a camera 0 is the camera 16 in FIG. 1A, and a camera 1 is the camera 13 in FIG. 1A. Additionally, a joint ID of each joint in a case where the total joint number of a single human body is J is described as j (0≤j<J), and a joint having the joint ID of j is described as a joint j. Moreover, in a case where F frames, the number is the same as that of the images continuous and synchronized in the temporal direction, are inputted from each camera, a frame ID indicating each frame is described as f (0≤f<F), and a frame (a captured image) having the frame ID of f is described as a frame f.

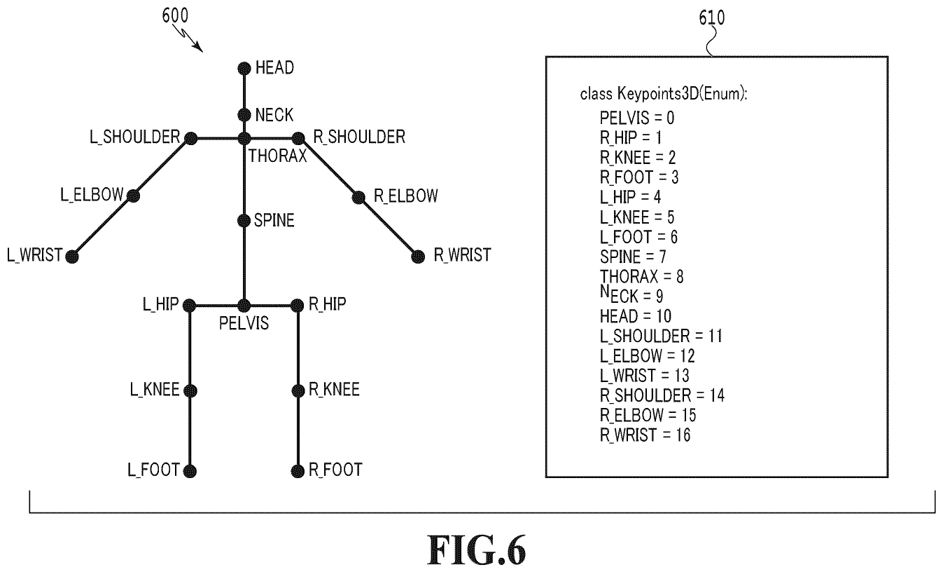

FIG. 6 is a diagram describing definition of each joint indicated by the skeleton information of the human body. The later-described three-dimensional reconstruction result becomes good by using a method of stably detecting each position defined with meaning in advance as a joint example of skeleton information 600. Additionally, an example of the definition of the joint j having the joint ID of j is illustrated in a list 610 in FIG. 6. The joint number of the skeleton of the human body illustrated in FIG. 6 is 17; however, this is an example, and there is no limitation about the definition of the joint number in the present embodiment. Even in a case where each joint is detected by using the definition of the skeleton of the human body different from that in FIG. 6, it is possible to similarly execute the following processing.

Next, the CPU 301 converts the position information in the two-dimensional coordinates into the position information in the three-dimensional camera coordinates by receiving an estimation result of the position of each joint in the two-dimensional coordinates continuous in the temporal direction and executing temporal convolution of a fixed length frame. It is possible to execute the method of converting the position information in the two-dimensional coordinates into the position information in the three-dimensional camera coordinates by a method disclosed in Dario Pavllo, Christoph Feichtenhofer, David Grangier, Google Brain, and Michael Auli.3D human pose estimation in video with temporal convolutions and semi-supervised training. In CVPR, 2019. (Non-Patent Literature 6), for example.

In S402, according to the above-described processing flow, the three-dimensional positional coordinates in each camera coordinate system of all the joints of the target person 11 are obtained for the frames of the entire movie sequence as the three-dimensional reconstruction target.

In FIGS. 5A and 5B, skeleton estimation 502 indicates the skeleton estimation executed on the input image 500 in S402, and skeleton information 504 indicates a shape of the skeleton of the human body expressing the joint positions of the target person 11 obtained as a result of the skeleton estimation 502. Skeleton estimation 503 indicates the skeleton estimation executed on the input image 501 in S402, and skeleton information 505 indicates a shape of the skeleton of the human body indicating the joint positions of the target person obtained as a result of the skeleton estimation 503.

In S403, the CPU 301 executes the camera calibration 1 to estimate the camera parameter of each camera p with rough accuracy. In the present embodiment, the number of the cameras used for the camera calibration is small. Therefore, with the camera calibration 1 being executed, the position and the orientation of the camera that are correct to some extent are estimated with rough accuracy, and thus it is possible to appropriately execute processing in a subsequent stage. The camera calibration 1 is executed by using the images obtained by the image capturing by each of the small number of cameras having only a few common visual fields. Therefore, the camera calibration 1 is executed based on the position of each joint indicated by the pieces of skeleton information 504 and 505 of the human body obtained by the skeleton estimation in S402.

As described above, in S402, the executed estimation is not the execution of the joint position of a learned person in a learned environment but the execution of the joint position of the target person 11 in the testing environment in which the image capturing is executed for the first time. Therefore, the position information of each joint obtained by the skeleton estimation in S402 includes a certain error.

In the present embodiment, the time code for the synchronized image capturing is applied to the captured image (frame) obtained by the image capturing by each of the multiple cameras 13 and 16. Therefore, the skeleton information estimated from the images to which the synchronized time codes are applied provides a restriction indicating that the images are the same in the world coordinate system, and optimization calculation is executed. Thus, it is expected that the position of each joint indicated by each piece of the estimated skeleton information is updated to the position close to the correct answer and converges.

In a case where there is only one frame in the input image, the information about the target person 11 is insufficient, and it is difficult to execute the camera calibration with high accuracy. Therefore, multiple frames obtained by the image capturing for a scale of a few minutes in the temporal direction are utilized to improve the accuracy of the camera calibration. Additionally, since the target person 11 gives a performance and moves around in a viewing angle across the multiple frames, it is possible to obtain the joint positions observed between the multiple cameras in synchronization in many regions within the captured image.

In a case where Video Pose 3D in Non-Patent Literature 6 is used to estimate a human body region three-dimensionally from the input images and the joint positions are obtained, the initial skeleton information is obtained by being individually inputted and estimated by each camera and each frame. In this case, normally, the entire scale such as a length between the joints of the skeleton of the same person needs to be constant in all the pieces of skeleton information. However, as described above, the pieces of skeleton information 504 and 505 obtained from the input images 500 and 501, respectively, have estimation results slightly different from each other. Here, first, the CPU 301 executes optimization to minimize a variance of the lengths of all the joints estimated from the same person who is image-captured by the cameras in synchronization. Now, a specific internal camera parameter calibrated in advance in each already-known camera p (0≤p<P) is described as K^{p}. Additionally, the position and the orientation of the camera are expressed by using R^{p} and t^{p}, and an object is to estimate this parameter set <R^{p}, t^{p}>.

The position of the joint j in the three-dimensional world coordinates estimated form the frame f out of the images obtained by the image capturing by the camera p is expressed as X_{j, f}. Additionally, the position of the joint j of the three-dimensional coordinates in the camera coordinate system in the camera p is described as X^{p}_{j, f}. Additionally, the likelihood of the position of corresponding each joint j is described as L^{p}_{j, f}. In this case, it is possible to express the position X^{p}_{j, f} of the joint j in the camera coordinate system in the camera p in a case where the camera p captures the images as Mathematical Expression 1.

$${X}_{j , f}^{p} = {R}^{p} {X}_{j , f} + {t}^{p} \qquad [ Mathematical Expression 1 ]$$

It is assumed that the position of the joint j is represented by x^{p}_{j, f} on the two-dimensional image obtained by the image capturing by the camera p. In this case, in the camera p, a relationship between the position x^{p}_{j, f} of the joint j on the two-dimensional image and the position X^{p}_{j, f} of the joint j on the original three-dimensional coordinates can be expressed by Mathematical Expression 2 by using the internal parameter K^{p} and the Mathematical Expression 1.

$$[ \begin{matrix}{x}_{j , f}^{p} \\ 1\end{matrix} ] = \frac{α}{\vert {X}_{j , f}^{p} \vert} {K}^{p} {X}_{j , f}^{p} = \frac{α {K}^{p} ( {R}^{p} {X}_{j , f} + {t}^{p} )}{\vert {X}_{j , f}^{p} \vert} , α = const . \qquad [ Mathematical Expression 2 ]$$

As with the Mathematical Expression 1, it is assumed that a direction from a particular joint toward a joint point defined in advance in the world coordinate system is described as v_{j, f}. In the camera coordinate system in a case of being image-captured by the camera p, a direction v^{p}_{j, f} from the particular joint toward the joint point defined in advance can be expressed by Mathematical Expression 3.

$${v}_{j , f}^{p} = {R}^{p} {v}_{j , f} \qquad [ Mathematical Expression 3 ]$$

Note that, the direction v_{j, f} defined herein is a direction vector for the sake of expediency to define the direction of each joint point, and it is expected that one vector is defined for each joint. For example, in a case where a reference joint point defined in advance is HEAD (j=10) illustrated in FIG. 6, v^{p}_{9, f} in a case of j=9 (NECK) is a vector representing a direction from a neck to a head and a length from the neck to the head. In a case where the definition is a vector from each joint to an adjacent coupled joint and duplications are included, 17 vectors are obtained from each frame. In the present embodiment, it is described under the assumption that the 17 vectors v^{p}_{j, f} are obtained from the frame f of the camera p.

The number of the input frames inputted from each camera in synchronization is F, and the joint number of the target person 11 is J. In a case where the target person 11 is image-captured in all the frames, the total number of the direction vectors v_{j, f} that can be used for the camera calibration is J×F. Therefore, Mathematical Expression 4 is obtained by transposing two sides of the Mathematical Expression 3 for the J×F three-dimensional directions.

$${[ {v}_{0 , 0}^{p} ⋯ {v}_{J - 1 , F - 1}^{p} ]}^{⊤} = {[ {v}_{0 , 0} ⋯ {v}_{J - 1 , F - 1} ]}^{⊤} {R}^{{p}^{⊤}} \qquad [ Mathematical Expression 4 ]$$

Then, [v^{p}_{0, 0} . . . v^{p}_{J-1, F-1}]^{T} in the Mathematical Expression 4 is described as V^{p}, and likewise, [v_{0, 0} . . . v_{J-1, F-1}]^{T} is described as V As a result, the Mathematical Expression 4 is expressed as Mathematical Expression 5.

$${V}^{p} = {VR}^{{p}^{⊤}} \qquad [ Mathematical Expression 5 ]$$

Here, the number of the cameras currently used for the image capturing is P, and the camera ID is p (0≤p<P); for this reason, it is possible to obtain an expression as Mathematical Expression 6.

$$[ {V}^{0} ⋯ {V}^{p - 1} ] = V [ {R}^{{0}^{⊤}} {⋯R}^{P - {1}^{⊤}} ] \qquad [ Mathematical Expression 6 ]$$

In this case, [V⁰ . . . V^{P-1}] is rank 3, and it is possible to obtain an expression as Mathematical Expression 7 by singular value decomposition.

$$[ \begin{matrix}{V}^{0} & … & {V}^{P - 1}\end{matrix} ] = {YDZ}^{⊤} \qquad [ Mathematical Expression 7 ]$$

Thus, in a case where an arbitrary 3×3 matrix that can be inverted is M, it is possible to factor as Mathematical Expression 8.

$$V = {YDM}^{- 1} , [ \begin{matrix}{R}^{{0}^{⊤}} & … & {R}^{P - {1}^{⊤}}\end{matrix} ] = {MZ}^{⊤} \qquad [ Mathematical Expression 8 ]$$

Here, a camera orientation matrix obtained by selecting M is in orthonormal expression, and a recovered direction is normalized. Thus, it is possible to obtain R^{p}.

Additionally, once rotation of the camera is accordingly obtained, it is possible to estimate translation by collinear restriction and coplanar restriction as described in I. Hartley and A. Zisserman, Multiple View Geometry in Computer Vision. Cambridge University Press, ISBN: 0521623049, 2000. (Non-Patent Literature 7). Therefore, it is possible to obtain t^{p}.

Thus far, for the sake of simple description, a method of using all the J joint points detected in all the F frames image-captured by all the P cameras in synchronization is described. As described above, a detection point of each joint holds the likelihood L^{p}_{j, f} at the moment of the detection. Since it is unnecessary to use a point that is unreliable at the point of time of the detection, for example, the joint position in a case where the likelihood L^{p}_{j, f} is equal to or smaller than a certain threshold may not be utilized for the above-described calculation.

Thus far, a method of executing the estimation of the parameter set <R^{p}, t^{p}> in the camera p by executing linear camera calibration in S403 is described. In FIGS. 5A and 5B, camera calibration 508 is the camera calibration 1 in S403.

Comparing with the camera calibration using the already-known fixed pattern, since the camera calibration 1 is based on the joint position of the person obtained by the skeleton estimation, there is a high possibility that each estimated camera parameter includes an error.

Therefore, the joint position obtained by the skeleton estimation is utilized to execute bundle adjustment and further update the camera parameter to execute the camera calibration. In addition, the camera parameter estimated in S403 is utilized as an initial value to perform the three-dimensional reconstruction, and the camera calibration is executed while including a rendering loss that can be calculated by comparing a rendering image obtained as a result of the three-dimensional reconstruction and an actual image. This camera calibration is referred to as the camera calibration 2.

Thus, in the present embodiment, after the camera parameter indicating the position and the orientation of the camera is estimated with rough accuracy in S403, image information other than the skeleton of the human body is also utilized efficiently, and thus it is possible to improve the estimation accuracy of the camera parameter.

In S404, optimization processing of the parameter related to the camera calibration 2 and optimization processing of the parameter related to the three-dimensional reconstruction are executed. Processing in a case of executing the above processing is repetitive processing to reduce an accumulated error obtained by the later-described calculation expression to be equal to or smaller than a desired value.

A loss for the optimization processing is assumed to be a value based on two types of losses, which are a loss related to the bundle adjustment and a rendering loss related to the three-dimensional reconstruction. That is, a bundle adjustment step and optimization processing based on the rendering loss are executed simultaneously. Then, an entire loss is reduced by repeating the parameter update and the rendering.

FIG. 4B is a flowchart illustrating details of S404. The details of S404 are described with reference to the flowchart in FIG. 4B and FIGS. 5A and 5B.

In S411, the CPU 301 obtains the camera parameter derived as a result of the camera calibration 1 in S403 and the parameter indicating the joint position of the human body derived as a result of S402 as the initial value.

Alternatively, in a case where the parameter is updated in S417 because the later-described total loss exceeds a threshold r, in S411, the CPU 301 obtains the camera parameter and the parameter of the joint position after the update.

In S412, the CPU 301 converts the position information of each joint in each of the camera coordinates estimated from each of the input images of the multiple cameras 13 and 16 into the position information in the world coordinates by using the external camera parameter obtained in S411. Then, the CPU 301 integrates the skeleton information. That is, a single piece of skeleton information indicating the position of each joint of the object in the three-dimensional world coordinates is generated. This is processing corresponding to processing 509 in FIGS. 5A and 5B.

For example, as for the position of the joint j in the world coordinates, it is assumed that X_{j,f}=A is obtained from X⁰_{j, f} of the camera 0 according to the Mathematical Expression 1, and X_{j, f}=B is obtained from X¹_{j, f} of the camera 1. Thus, the position X_{j, f} of the joint j in the world coordinates is obtained as a different value, which is A or B, by being affected by the error of R^{p} and t^{p} of the camera parameter, an estimation error of a skeleton estimator, and the like.

Therefore, in the present embodiment, the skeleton information is integrated by suppressing a phenomenon where a length and the like between the joints become unstable for each frame. A network that suppresses the above-described combined factors all at once is defined. In addition, in a case where X_{j, f} estimated from the image of each camera includes an error that is ΔX_{j, f} with respect to a true value, it is assumed that the skeleton information is integrated by estimating ΔX_{j, f} with respect to the input and correcting the value for the estimated error. Then, in the configuration, X_{j, f} corrected as a result of the integration is passed to Skeletal Transformation 510 in FIGS. 5A and 5B in the subsequent S413 and S414. As a method of suppressing the error by rule-based processing, for example, a penalty may be imposed in a case where the skeleton joint length of the same person is different depending on the observation time or the camera.

In S413, based on the integrated skeleton information and the camera parameter obtained in S411, the CPU 301 calculates a loss ε₁ based on the skeleton indicating the error related to the joint position on the two-dimensional coordinates.

In the present step, the loss based on the skeleton is defined out of the losses considered as the optimization target. Reprojection error minimization is formulated as a maximum likelihood estimation problem, and under the assumption that the estimation result of the position of the joint on the two-dimensional coordinates can be approximated with a normal distribution of a standard deviation σ, a difference from a reprojection joint is evaluated as a loss to reflect the right or wrong of the position and the orientation of the camera in a score. Therefore, the joint position obtained by reprojecting the position of the joint indicated in the world coordinates on the two-dimensional coordinates is described as a vector including a hat representing the reprojection for the optimization target parameters K^{p}, R^{p}, t^{p}, and X. X is the joint position indicated in the world coordinates after the integration in S412.

$$( {K}^{p} , {R}^{p} , {t}^{p} , X )$$

In this case, the loss ε₁ based on the skeleton indicating the error of the joint position on the two-dimensional coordinates can be expressed as Mathematical Expression 9.

$${ε}_{1} ( K , R , t , X ) = - {\sum }_{p = 0}^{P - 1} {\sum }_{f = 0}^{F - 1} {\sum }_{j = 0}^{J - 1} {L}_{j , f}^{p} log Q \qquad [ Mathematical Expression 9 ]$$

$$Q = \frac{1}{\sqrt{2 {πσ}^{2}}} exp ( - \frac{{‖ ( {K}^{p} , {R}^{p} , {t}^{p} , X ) - {x}_{j , f}^{p} ‖}_{2}^{2}}{2 {σ}^{2}} )$$

The Expression 9 is designed as a score that is accumulated as a score obtained by multiplying a negative log likelihood by the likelihood of each joint position of L^{p}_{j, f} for each joint detected. Since the joint position with a low likelihood L^{p}_{j, f} is unreliable as the detection point of the calibration target, this has an effect to decrease the impact on the loss accumulation as the optimization target.

The position X of the joint indicated by the integrated skeleton information is the position information on the three-dimensional coordinates. Therefore, in a case where the position of each joint j in the three-dimensional coordinates is projected onto the same two-dimensional flat surface as the input image and compared with the position x of the joint j in the original input image, an error occurs if the estimated parameter does not match the true value. Therefore, it is possible to calculate the loss ε₁ originated from the accuracy of the skeleton estimation according to the Mathematical Expression 9. In a case where the value that completely matches the true value is estimated as R^{p} and t^{p} and the true value of the position X of the joint of the skeleton is also estimated, the error is 0. Therefore, it is possible to achieve the camera calibration with high quality by the optimization to minimize the loss ε₁ in the Mathematical Expression 9.

In S414, the CPU 301 performs the three-dimensional reconstruction by using the camera parameter obtained in S411.

First, as illustrated in FIGS. 5A and 5B, the CPU 301 estimates a three-dimensional reconstruction result 506 in a space expressed as an Observation Space in which a voxel within a fixed three-dimensional space has color information and a density from the input image 500 obtained from the camera 16 (the camera 0). In addition, the CPU 301 estimates a three-dimensional reconstruction result 507 in a space expressed as an Observation Space in which a voxel within a fixed three-dimensional space has the color information and the density from the input image 501 obtained from the camera 13 (the camera 1).

A format of each of the three-dimensional reconstruction results 506 and 507 may be a format similar to the method disclosed in Non-Patent Literature 3. That is, as for the three-dimensional reconstruction result related to the target person 11 in the Observation Space, once the viewpoint and a line-of-sight direction in the learning are determined, R, G, and B and the density of sample points on a Ray at the point of time are accumulated in the order from a direction close to the viewpoint. Then, calculation is performed such that a result of the accumulation to a point at which the accumulated density reaches 1 is obtained as a rendering result. With this method, once the three-dimensional reconstruction result is obtained, it is possible to acquire the rendering result by providing an arbitrary testing viewpoint.

In the present embodiment, unlike Non-Patent Literature 3, in order to simplify the problem, in a case of acquiring and rendering the three-dimensional reconstruction result, the information related to appearance that each voxel has is defined as information that is completely diffusely reflected without being held as the parameter that is varied depending on a visual direction. Therefore, the two-dimensional image observed in a case of determining a particular viewpoint is automatically determined regardless of the visual direction once voxel positional coordinates in the three-dimensional space as the target of the projection on the two-dimensional flat surface is determined. Therefore, since the information related to the color information and the density returned from each voxel is simplified and modeled to be unvaried, it is possible to obtain the RGB value and the density returned from the corresponding voxel and to perform the rendering as long as the position X in the space of each three-dimensional reconstruction is obtained.

Note that, although the Observation Space is described as “a voxel within a fixed three-dimensional space that has the color information and the density,” it is unnecessary to express a model of NeRF expression, which has three-dimensional information related to the target person from the input image, in a voxel grid format. The model may be expressed in an MLP format such as a general NeRF. In a case of the voxel grid format, shape information is taken out easily. However, in a case where it is possible to take out the image viewed from an arbitrary viewpoint by querying an observation viewpoint, it is possible to calculate and optimize the rendering loss, and the setting that R, G, and B and the density are allocated to the voxel grid may be unnecessary.

As a matter of course, since the three-dimensional reconstruction is performed for a single camera viewpoint, at the early point of time of starting the learning, there is a great error in the three-dimensional reconstruction results 506 and 507 of the Observation Space. Therefore, next, the Skeletal Transformation 510 to deform the posture of the target person 11 in the three-dimensional reconstruction results 506 and 507 and integrate the three-dimensional reconstruction results 506 and 507 is performed.

Since the three-dimensional reconstruction results 506 and 507 are based on the images captured by the cameras in synchronization, the corresponding postures of the target person 11 in the three-dimensional reconstruction results 506 and 507 match on the world coordinates. Therefore, with the Skeletal Transformation 510 referring to the single piece of skeleton information integrated in S412, the CPU 301 deforms the postures of the target person 11 in the three-dimensional reconstruction results 506 and 507 into a standard pose and thus integrates the postures. With utilization of the integrated skeleton information, the three-dimensional reconstruction result of the human body in the learning process is converted into the three-dimensional reconstruction result in a Canonical Space by a weight of a rig determined according to the distance from each joint position. As a result, it is possible to acquire a three-dimensional reconstruction result 511 of the human body in a case of obtaining the standard pose in the Canonical Space.

Since the target person 11 postures freely while being image-captured, the posture of the target person 11 is different for each frame. Therefore, with the deformation of the target person 11 included in all the frames inputted from all the cameras into the standard pose as a common posture, it is possible to integrate the observation results stably for the point of the observation target. The standard pose defined in the Canonical Space is defined as the posture for the integration as described above. The standard pose may be any posture as long as it can be deformed into the common posture; however, a posture utilized generally is a standard posture state in a three-dimensional person shape called a Canonical T-pose, A-pose, and Y-pose. In a case where the conversion of the Skeletal Transformation to convert into the standard posture state is Tₛₖₑₗ, the Skeletal Transformation 510 can be expressed as the following Mathematical Expression 10.

$${T}_{skel} ( {U}^{p} , {X}_{f}^{p} ) = {\sum }_{j = 0}^{J - 1} {w}_{j}^{p} ( {U}^{p} ) ( {R}_{j}^{p} {U}^{p} + {t}_{j}^{p} ) \qquad [ Mathematical Expression 10 ]$$

In the Mathematical Expression 10, U^{p} is positional coordinates expression representing the inside of the region in which the model of the target person on which the three-dimensional reconstruction is performed is defined. Specifically, it is expression related to an entire region included in the Observation Space exemplified in the three-dimensional reconstruction results 506 and 507 as the estimation target. With the skeleton deformation (Skeletal Transformation) being performed according to the Mathematical Expression 10, the point in the Observation Space is calculated as inverse linear blend skinning mapped in the Canonical Space. W^{p}ⱼ represents a blend weight in the joint j in the Observation Space in a case of being observed by the camera p. This is utilized as a weight associated with U^{p} in the entire estimation target region according to a general method executed by a surface expressing the human body in human body animation of the computer graphics and the human body skeleton defined in association with the surface. Additionally, R^{p}ⱼ represents a rotation matrix in the joint j observed by the camera p, and t^{p}ⱼ represents a movement vector. R^{p}ⱼ, t^{p}ⱼ are the parameters obtained from the position of the joint j in the world coordinates in the skeleton information after the integration and the camera parameters R^{p}, t^{p} obtained in S411.

Now, in a case where the blend weight in the Canonical Space is W^{e}ⱼ, a relationship between W^{p}ⱼ and W^{e}ⱼ can be defined by Mathematical Expression 11.

$${w}_{j}^{p} ( U ) = \frac{{w}_{j}^{c} ( {R}_{j}^{c} {U}^{c} + {t}_{j}^{c} )}{{\sum }_{j = 0}^{J} {w}_{j}^{c} ( {R}_{j}^{c} {U}^{c} + {t}_{j}^{c} )} \qquad [ Mathematical Expression 11 ]$$

The Skeletal Transformation 510 images a matrix of a voxel grid type having the same or lower resolution as X, Y, and Z directions of the target space of the three-dimensional reconstruction. The weight parameter (the blend weight) of the rig obtained usually by weighting based on the distance from the skeleton joint position of the Canonical Pose and utilized in a case of animation is stored. The parameter space holding the 17 weight parameters corresponding to the joint number is held, and the parameter set is optimized in the learning process. With the parameter set, the three-dimensional reconstruction results of the human body are converted between the Observation Space and the Canonical Space.

Specifically, it is assumed that the resolution of the space including the target person 11 in a case of the three-dimensional reconstruction is 640×640×640, for example. The matrix of the weight parameter of the rig of the above-described skeleton is, for example, 32×32×32 obtained by down-converting the above-described space, and there are 17 matrices, which corresponds to the joint number. The weight parameter in a case of the Skeletal Transformation of each human body region in a case of restoring to the actual resolution is obtained simply by trilinear interpolation. Even in a case where the three-dimensional reconstruction of the human body is not described in the voxel grid format, it is possible to obtain each RGB and density in a case where the three-dimensional position is inputted as a query. Therefore, the parameter set on a Skeletal Transformation side may be held in a table of the voxel grid format.

In addition, as a result of the Skeletal Transformation 510, the two three-dimensional reconstruction results 506 and 507 are integrated. For example, in a case where only one shot is captured by the two cameras in synchronization, the two three-dimensional reconstruction results 506 and 507 estimated from the two images by the deformation according to the Mathematical Expression 10 become the three-dimensional reconstruction result 511 of the standard pose. In this case, in the NeRF, the RGB and the density are estimated for each of the X, Y, and Z directions sampled with a ray corresponding to a pixel for each image; however, the ray is not straight and distorted due to the deformation according to the Mathematical Expression 10. However, since each ray is only for determining the sample point, the ray is treated similarly, and the sample points defined from the input images are integrated under the assumption that the sample points are observed in the same world coordinate system and have the corresponding estimation values within the same space; thereby, the optimization proceeds. Here, although it is expressed as integration, this is a state in which a single scene is reconstructed by combining the observation results of the multiple viewpoints in a case of the NeRF that is done with the original camera calibration and an enormous amount of images are inputted.

In S415, the CPU 301 calculates a rendering loss F₂. As described above, in S414, the three-dimensional reconstruction result 511 is obtained by the conversion into the Canonical Space. The CPU 301 executes inverse conversion of the Skeletal Transformation 510 on the three-dimensional reconstruction result 511 to restore to the three-dimensional reconstruction result of the Observation Space. Specifically, in a case where the correct answer image is the frame f, the information of the three-dimensional shape of the target person 11 of the Canonical Space is converted into the posture of the target person 11 in the frame f by the inverse conversion. As a result, a three-dimensional reconstruction result 550 of the Observation Space holding the information of the three-dimensional shape of the target person 11 in the posture in a case of capturing the image of the frame f is obtained. The CPU 301 inputs the camera parameter <R^{p}, t^{p}> obtained in S411 as the information indicating the viewpoint of each camera to the three-dimensional reconstruction result 550. Then, the CPU 301 compares an output image outputted as a result and the frame f of the camera p as the correct answer image and calculates the rendering loss F₂ as a result of the comparison.

For example, in a case of FIGS. 5A and 5B, viewpoint information <R⁰, t⁰> of the camera 0 is inputted to the three-dimensional reconstruction result 550 obtained by converting the posture of the target person 11 into the postures of the input images 500 and 501. Then, an output image 551 of the Observation Space viewed from the viewpoint of the camera 0 is outputted, and the output image 551 and the input image 500 as the correct answer image are compared. Likewise, viewpoint information <R¹, t¹> of the camera 1 is inputted to the three-dimensional reconstruction result 550, and an output image 552 of the Observation Space viewed from the viewpoint of the camera 1 is outputted. Then, the output image 552 and the input image 501 as the correct answer image are compared. The comparison is performed on all the F frames, and the rendering loss ε₂ is calculated based on the comparison.

Specifically, in a case where the rendering loss is ε₂, it is possible to define ε₂ as Mathematical Expression 12.

$${ε}_{2} ( K , R , t , X ) = {\sum }_{p = 0}^{P - 1} {\sum }_{f = 0}^{F - 1} {‖ Γ [ {F}_{c} ( {T}_{skel} ( {U}^{p} , {X}_{f}^{p} ) ) , ( {R}^{p} , {t}^{p} ) ] - {I}_{f}^{p} ‖}_{2}^{2} \qquad [ Mathematical Expression 12 ]$$

In the Mathematical Expression 12, I^{p}_{f} is the correct answer image that is an image with the frame ID of f of the input camera p (the frame f). F_{c} represents the MLP that outputs R, G, and B and the density in a case where an input point is provided. The point provided to Fₑ is as defined by the Mathematical Expression 10. Since it is assumed that all the points are diffusely reflected, F_{c} returns the same value to the point of the same positional coordinates no matter what view is provided. Γ is a volume renderer. Γ represents the output image of the Observation Space viewed from the viewpoint indicating the position and the orientation <R^{p}, t^{p}> of the camera p by inversely converting into the posture of the frame f from the Canonical Space to the Observation Space. Thus, a difference in the pixel value between the two-dimensional image (the output image), which is obtained in a view in a case where the position and the orientation <R^{p}, t^{p}> of the camera is provided, and the two-dimensional image I^{p}_{f}, which is the correct answer image for the learning, is calculated. Thus, the difference between the volume rendering by the estimation and the actual observation image is accumulated for all the F frames and all the P cameras to obtain ε₂.

Thus, the rendering loss based on a difference loss between the rendered image and the actual image is calculated, the rendered image being obtained by performing the three-dimensional reconstruction of the human body and integrating the corresponding estimation results as a result of regular expression of the result of the three-dimensional reconstruction.

In S416, the CPU 301 determines whether the loss ε₁ and the loss ε₂ satisfy Mathematical Expression 13. That is, whether the loss based on the loss ε₁ and the loss ε₂ is equal to or smaller than the threshold τ is determined. Each parameter obtained by the minimization is solved assuming that it satisfies the Mathematical Expression 13.

$$τ \geq \vert {λε}_{1} ( K , R , t , X ) + ( 1 - λ ) {ε}_{2} ( K , R , t , X ) \vert , 0 \leq λ \leq 1 \qquad [ Mathematical Expression 13 ]$$

λ is a weight that adjusts whether to prioritize the loss ε₁ calculated based on the skeleton of the human body or the loss ε₂ calculated based on the rendering result. λ may be a fixed value. For example, the learning may be performed with only the loss ε₂ where λ is 0, or the learning may be performed with only the loss ε₁ where λ is 1. λ may be used for scheduling to change weighting between an early phase of the learning and a later phase of the learning. For example, in the early phase of the learning, the learning may start with a value with λ close to 1 to perform the learning based on the estimated skeleton of the human body, and as the learning proceeds, the learning may be performed with higher priority to the error minimization based on the rendering result.

In S416, if the CPU 301 determines that the Mathematical Expression 13 is not satisfied, the processing proceeds to S417. In S417, the CPU 301 updates the parameter. S417 corresponds to camera parameter update processing 541 in FIGS. 5A and 5B. After updating the parameter, the CPU 301 returns the processing to S411. Then, the CPU 301 obtains the parameter updated in S411 and executes S412 to S417 by using the updated parameter. Then, S411 to S417 are repeated until the Mathematical Expression 13 is satisfied, that is, until the processing reaches termination conditions.

The updated parameter is, for example, the camera parameter <R^{p}, t^{p}> of the camera p. For example, the CPU 301 provides a small change to the camera parameter <R^{p}, t^{p}> determined in the camera calibration 1 to update the camera parameter. Additionally, the position X of the joint j in the world coordinates in the skeleton information integrated in S412 is updated. Additionally, once the camera parameter and the position of the joint are updated, the parameter used for the Skeletal Transformation 510 is updated. Therefore, the parameter set (the weight) representing the information of the three-dimensional shape of the target person 11 in the three-dimensional reconstruction result 511 in the Canonical Space is also updated. In addition, since the updated three-dimensional reconstruction result 511 is inversely converted, the parameter set representing the information of the three-dimensional shape of the target person 11 in the three-dimensional reconstruction result 550 in the Observation Space obtained as a result of the inverse conversion is also updated.

In S416, if the CPU 301 determines that the Mathematical Expression 13 is satisfied, the learning ends. Then, the CPU 301 outputs the camera parameter, the skeleton information, and the three-dimensional reconstruction results 511 and 550 in a case where the Mathematical Expression 13 is satisfied. Thus, the CPU 301 can determine the camera parameter of each camera p. In FIGS. 5A and 5B, the processing corresponds to parameter determination processing 542.

Here, as a summary of the processing in S404, for example, in a case where each camera p captures the images for one minute at 30 fps, 1800 images are inputted from each camera p. In a case of the two cameras as illustrated in FIGS. 5A and 5B, 1800 input images 500 and 1800 input images 501 are inputted in FIGS. 5A and 5B.

In a case where the three-dimensional reconstructions 516 and 517 are executed by the NeRF, which is the method described in Non-Patent Literature 3, it is completely impossible to perform the three-dimensional reconstruction immediately after the learning starts; for this reason, something like a random pale-colored point group is reconstructed in each of the three-dimensional reconstruction results 506 and 507.

In the early phase of the learning, the three-dimensional reconstruction results 506 and 507 for the 3600 (1800+1800) images that are not construable by human are obtained. The three-dimensional reconstruction results pass through a network of the skeletal transformation 510 that is not sufficiently learned. Thus, in the Canonical Space, the three-dimensional reconstruction result 511 including the information of the three-dimensional shape of the person in the standard pose, which is integrated pieces of appearance information obtained from all the learning images, is obtained. Note that, in the present embodiment, the three-dimensional reconstruction result 511 itself does not need to be in a state browsable by reading with a CG tool. In the present embodiment, the three-dimensional reconstruction result is the model such as the NeRF and therefore expressed as a weight parameter set of the MLP.

The parameter as the update target in a case of the learning is the parameter set of the MLP that expresses the target person in the Canonical Space, and the update is executed according to a result of the error minimization. The error calculation is performed by comparing with the input image with the identified true value as the learning image; therefore, the input image is taken out of the MLP in the Observation Space and compared. The sum of the errors calculated by the comparison in this process is the rendering loss.

For example, since the images outputted from the three-dimensional reconstruction results 506 and 507 in the Observation Space include no information of a back side of the target person in the early phase of the learning, it is impossible to render an image appearing like a person. However, once the learning ends, as a result of integrating the entire circumference images of the person, the person in the Canonical Space can be obtained with high accuracy. Therefore, according to the above, with the inverse conversion by the MLP of the Skeletal Transformation, the back side of the target person that is not shown in the input image is also reconstructed in the three-dimensional reconstruction result 550 in the Observation Space.

In the general NeRF learning, it is impossible to perform complicated learning with a single input image. Therefore, in the present embodiment, first, the parameter is roughly estimated from the single input image. Then, pieces of information of an enormous amount of the input images are integrated, and the three-dimensional reconstruction result 511 in the Canonical Pose is obtained. Then, with reference to the three-dimensional reconstruction result of the Canonical Pose, the information such as a posture parameter of the person in the single input image is utilized, and the reconstruction in a desired posture is executed in the Observation Space.

In the present embodiment, it is assumed that the three-dimensional reconstruction is performed on only for the image-captured number, as a usual application, of the moving images of the target person, the object is achieved as long as the optimization can be executed and the three-dimensional reconstruction can be performed for all the input images.

Here, a method in a case where obtainment of the three-dimensional reconstruction result of the posture that is not included in the input image after the learning ends is desired is also described. In this case, instead of extracting the skeleton from the input image in the usual learning process, a desired pose is provided to the skeleton having the same lengths between all the joints, and the input is performed similarly. Thus, it is possible to inversely convert the learned MLP obtained in the Canonical Space and to obtain the MLP parameter set of the target person in the desired posture that is not included in the input image in the Observation Space.

Thus, in the present embodiment, the Mathematical Expression 13 considering the sum of the losses indicating the error, which is defined by the Mathematical Expression 9 and the Mathematical Expression 12, is described to be used as an expression for the optimization. The conditions expressed by the Mathematical Expression 13 are satisfied by the optimal value search of the parameter related to both the camera parameter and the skeleton of the human body. Therefore, the accuracy of the camera calibration is improved by optimizing the parameter as the optimization target in S411 to S417. In addition, with the execution of the learning to minimize the sum of the losses indicating the error, which is defined by the Mathematical Expression 9 and the Mathematical Expression 12, it is possible to obtain a good three-dimensional reconstruction result, eventually.

That is, in a case of a state in which the Mathematical Expression 13 is satisfied, both the three-dimensional reconstruction result 511 in the Canonical Space and the three-dimensional reconstruction result 550 in the Observation Space are in a good state. In the Skeletal transformation 510, the parameter that allows for both types of the conversions is learned. Therefore, once the learning ends, it is possible to perform the deformation therebetween freely as with the posture deformation by the skeleton of CG animation. Therefore, the three-dimensional reconstruction results of both the Observation Space and Canonical Space are good. The three-dimensional reconstruction result 550 in the Observation Space is utilized for the calculation of the difference from the two-dimensional input image, and the Canonical Space is a space for the actual parameter update.

Additionally, even in a case where the skeleton information indicating the posture that is not included in the learning is put into the human body in the Canonical Space, to some extent, it is also possible to perform the three-dimensional reconstruction of the posture that is not inputted in a case of the learning.

As described above, according to the present embodiment, as for the small number of cameras for the three-dimensional reconstruction, the camera parameter is determined appropriately even without a step of capturing the images of the chessboard for the camera calibration. In addition, according to the present embodiment, it is possible to implement the three-dimensional reconstruction using the images inputted from the small number of cameras and to improve the quality of the image rendered from a new testing viewpoint.

Note that, in the description of the present embodiment, the input image is described as the captured image itself that is obtained by the image capturing by the camera p. For example, the input image may be an image that is obtained by executing semantic region division by a method such as Mask-RCNN on the captured image and extracting only a region related to the human body. Additionally, although it is described that the external camera parameter is obtained in the camera calibration, the internal camera parameter may also be obtained simultaneously.

Additionally, in the description of the present embodiment, a case where the F frames in the temporal direction obtained by the synchronized image capturing are inputted is described. The F frames may be frames of a moving image that is inputted offline after the image capturing ends or may be a frame inputted as real-time processing during the image capturing of the moving image. Moreover, in a case where the F frames are a part of the moving image, the learning and the estimation processing may be performed for each frame.

Moreover, although the three-dimensional reconstruction related to the person is described in the present embodiment, the generality is not lost even in a case where the target is other than a person. For example, in a case where the image capturing target is an animal other than a human, it is possible to obtain a similar effect for various animals such as a dog and a cat by executing a method of performing the skeleton estimation of an animal instead of performing the skeleton estimation of the person.

### Second Embodiment

In the first embodiment, it is described that the object as the image capturing target is the single person. In the present embodiment, a method of the camera calibration and the three-dimensional reconstruction in a case where the images of multiple people, an animal other than a person, a non-living object, and the like are captured by multiple cameras in synchronization is described. The number of the image capturing cameras is a small number, which is two to three, as with the first embodiment. Additionally, a method of simultaneously executing the camera calibration and the three-dimensional reconstruction by utilizing the captured images obtained by the image capturing by the small number of cameras in synchronization without forcing the videographer to perform an operation for the camera calibration in addition to the image capturing is described. In the present embodiment, a difference from the first embodiment is mainly described. A portion that is not particularly described is the same configuration and processing as that of the first embodiment.

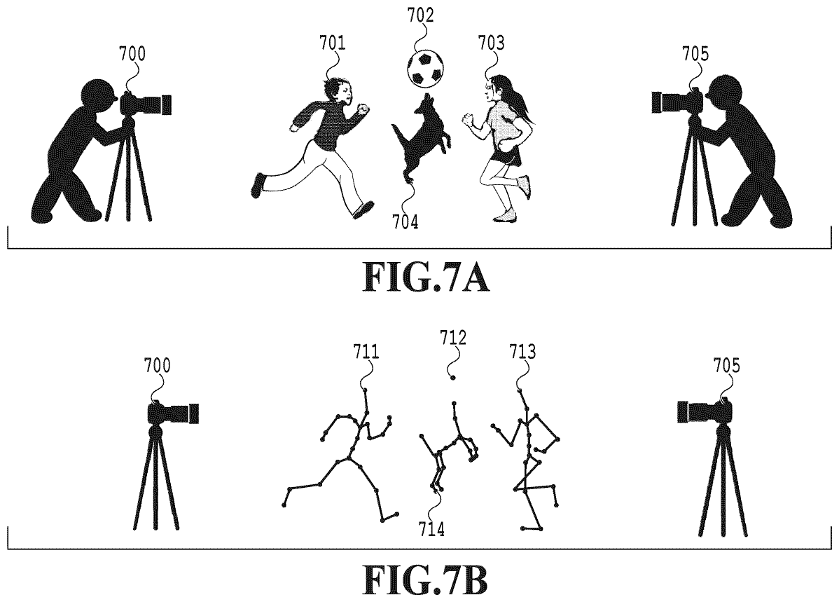

FIG. 7A is a diagram illustrating an example of an image capturing environment expected in the present embodiment. For example, an operation in a case where family members capture the images of a scene in which a person 701 and a person 703, two people, move like playing using a ball 702 with a dog 704 by two cameras 700 and 705 for recording is expected.

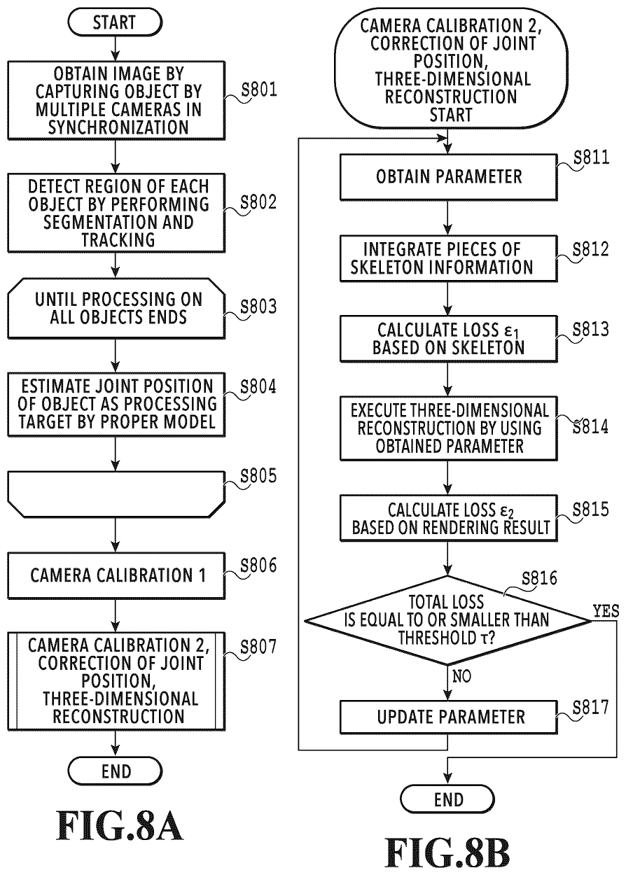

FIGS. 8A and 8B are flowcharts describing a flow of processing of the camera calibration and the three-dimensional reconstruction in the present embodiment. FIGS. 8A and 8B are flowcharts in the present embodiment corresponding to the flowcharts in FIGS. 4A and 4B.

As description of the flowcharts in FIGS. 8A and 8B, processing in a case where the two cameras 700 and 705, which are two capture groups, capture the images of a target object group in synchronization for about a few minutes in the temporal direction is described. Additionally, in the description of FIGS. 8A and 8B, it is assumed that the parameter related to the camera that is obtained by the camera calibration is related to the external camera parameter.

In S801, the CPU 301 receives the movie (the video) obtained with the cameras 700 and 705 capturing the images of the target object of the three-dimensional reconstruction in synchronization. After the image capturing starts, the multiple frames as the captured images continuous in the temporal direction are received as the input images including the object. As described above, the multiple objects are included in the image capturing scene expected in the present embodiment. It is assumed that the input images received in S801 include the person 701, the person 703, the dog 704, and the ball 702. In S801, with reference to the time code embedded in each captured image (frame), the image set that is captured by different cameras and to which the same time code is applied is obtained, and thus it is possible to perform the subsequent processing.

In S802, the CPU 301 detects the region of each object from the input images including the multiple objects. Specifically, the CPU 301 detects the region indicating the object in the input images by instance segmentation, tracks the same target in the continuous images (frames) in the temporal direction, and applies the same identifier (ID). The ID is referred to as an instance ID. Additionally, the object to which the instance ID is applied is also referred to as an instance. As a method of executing the instance segmentation and the tracking, it is possible to achieve the instance segmentation and the tracking by a method as described in Voigtlaender P, Krause M, Osep A, Luiten J, Sekar BBG, Geiger A, Leibe B. Mots: Multi-object tracking and segmentation. In CVPR, 2019. (Non-Patent Literature 8).

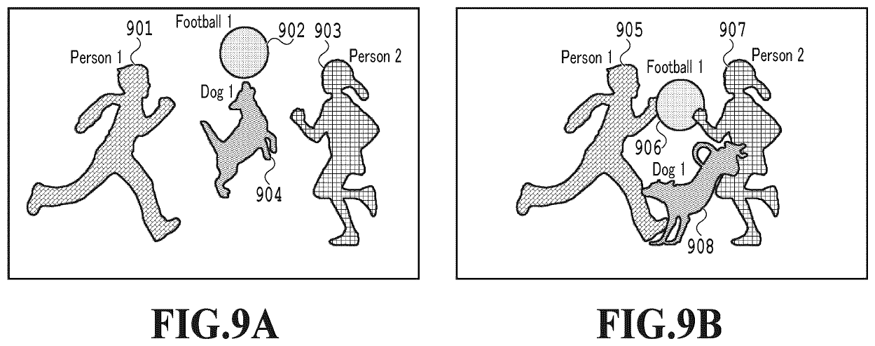

FIG. 9A is a diagram illustrating an example of a result of performing the instance segmentation and the tracking on a particular input image. In general, the regions of the instances are individually distinguished in the instance segmentation, and thus it is possible to provide an individual instance ID to the region of each object in the image including the multiple objects. As illustrated in FIG. 9A, not only person regions 901 and 903 are classified by a class name that is Person but also each person is identified and the instance ID is applied to perform the tracking. That is, the instance ID, Person1, is applied to the person region 901, and the instance ID, Person2, is applied to the person region 903. The instance ID, Football1, is applied to an object region 902. The instance ID, Dog1, is applied to a dog region 904. Thus, the regions of the instances are distinguished, and the objects included in the images continuous in the temporal direction are tracked. In addition, with the tracking, even in a case where the objects are overlapped and the one object is covered, a boundary between the objects is distinguished.

Therefore, in S802, as illustrated in FIG. 9A, the CPU 301 can generate a mask indicating the region of each object in the input image. Therefore, even in a case where the objects overlap, as illustrated in FIG. 9B, the mask is generated while distinguishing the overlapping objects as regions different from each other. Unlike the first embodiment, multiple objects overlap and cover each other in the present embodiment. Therefore, it is possible to obtain an accurate result for the regions in which the objects separated from each other and overlap by utilizing information of the mask illustrated in FIG. 9B.

The subsequent S803 to S805 are loop processing. In S803, the instance ID of the processing target is selected from the instance IDs that are consistent in the temporal direction and obtained in S802, and in S804, the skeleton estimation similar to that in the first embodiment is executed for the instance indicated by the instance ID of the processing target.

S804 is a step corresponding to the skeleton estimation in S402 of the first embodiment. In S804, the CPU 301 executes the skeleton estimation that can be used for the camera calibration by using a detection model corresponding to the class indicated by the instance ID of the processing target.

In a case where the instance indicated by the instance ID of the processing target is the person 701 and the person 703, as with the first embodiment, the learned model that estimates the skeleton of the human body is used as the detection model to execute the skeleton estimation.

FIG. 7B is a diagram describing a result of the skeleton estimation. Pieces of skeleton information 711 and 713 of the people obtained by performing the skeleton estimation from the images obtained by the image capturing in FIG. 7A by the cameras 700 and 705 are obtained.

In a case where the instance indicated by the instance ID of the processing target is an animal other than a human such as the dog 704, the CPU 301 executes the skeleton estimation of the animal by a method described in Libby Z, Timothy D, Jesse M, Bence O, Scott L. Animal pose estimation from video data with a hierarchical von Mises-Fisher-Gaussian model. In AISTATS, 2021. (Non-Patent Literature 9).

In a case where the skeleton estimation of the animal is executed, it is possible to treat skeleton information 714 obtained as a result similarly to the skeleton information of the human body. That is, it is possible to utilize the skeleton information 714 for the camera calibration 1. Even in a case where the joint number of the skeleton of the human body and the joint number of the skeleton of the animal are different according to the difference between the definitions of the skeletons based on the difference in the methods of the skeleton estimation, it is possible to perform the subsequent processing.

As for a non-living material such as the ball 702 with the instance ID of Football, for example, in a case where the class is a sphere, a sphere model is utilized as similar processing in a case where it is determined as a non-living material rigid body model. Therefore, in a case where the class is the sphere, the CPU 301 executes general sphere fitting and obtains the positional coordinates of the center of the sphere. Then, based on the position and the orientation of the camera, in the sphere fitting, ellipse fitting is performed two-dimensionally on ball regions in the multiple images captured in synchronization, and the center of the ellipse is obtained. Then, processing in which the ray is extended from the center of a sensor toward the center of the ellipse of the multiple cameras, the center of the sphere is expected to be at the center position of the nearest point of each ray, and a radius of the sphere is fitted to overlap a two-dimensional ellipse the most may be executed. Thus, the position of a center 712 of the sphere in a case of being viewed from each camera is estimated. Thus, as for the non-living material, a position such as the center may be obtained as a part. The centers of the spheres moving in the temporal direction can be all utilized for the camera calibration 1 in S805.

Alternatively, in a case where the person or the animal is included in the image capturing target, the skeleton estimation is executed on the person or the animal. Therefore, it is possible to estimate the position and the orientation of the camera by utilizing the estimated joint position as with the first embodiment. Therefore, in S803, in a case where the instance ID indicating the non-living material such as the ball 702 is selected as the processing target, it may be determined that there is no detection model corresponding to the target class, and the CPU 301 may skip S804.

In S806, the CPU 301 estimates the initial value of the external camera parameter indicating the position and the orientation of each camera by the camera calibration 1 as with that in the first embodiment by utilizing the joint position indicated by the skeleton information.

Since the multiple objects are included in the input image in a case of the present embodiment, the object covers the other object frequently. Therefore, as illustrated in FIG. 9B, person regions 905 and 907, a dog region 908, and a ball region 906, which are the regions of the objects, may be detected overlapping each other. Thus, in a case where a certain object is covered, mainly, the accuracy of the joint position related to a covered region is deteriorated in the skeleton information of the human body and the skeleton information of the animal.

Therefore, in S802, it is favorable to execute the camera calibration 1 by using the position information of only the joint out of the joints of the target instance that is included in the region indicated by the mask of the target instance obtained by the instance segmentation. That is, it is desirable to respond by executing the camera calibration 1 so as not to utilize the position information of the joint included in the covered region. Therefore, as described in the first embodiment, an estimation likelihood related to the joint position may be utilized.

S807 is a step corresponding to S404 in FIG. 4A. In S807, the CPU 301 performs the camera calibration 2, correction of the joint position, and the three-dimensional reconstruction. A flowchart in FIG. 8B is a flowchart describing details of the processing in S807. S811 to S817 are processing similar to S411 to S417 in the first embodiment. That is, the bundle adjustment utilizing the initial value of the camera parameter of each camera estimated by the camera calibration 1, the joint position of each instance (each object), and the like, and the learning to minimize the rendering loss in the learning process are executed.

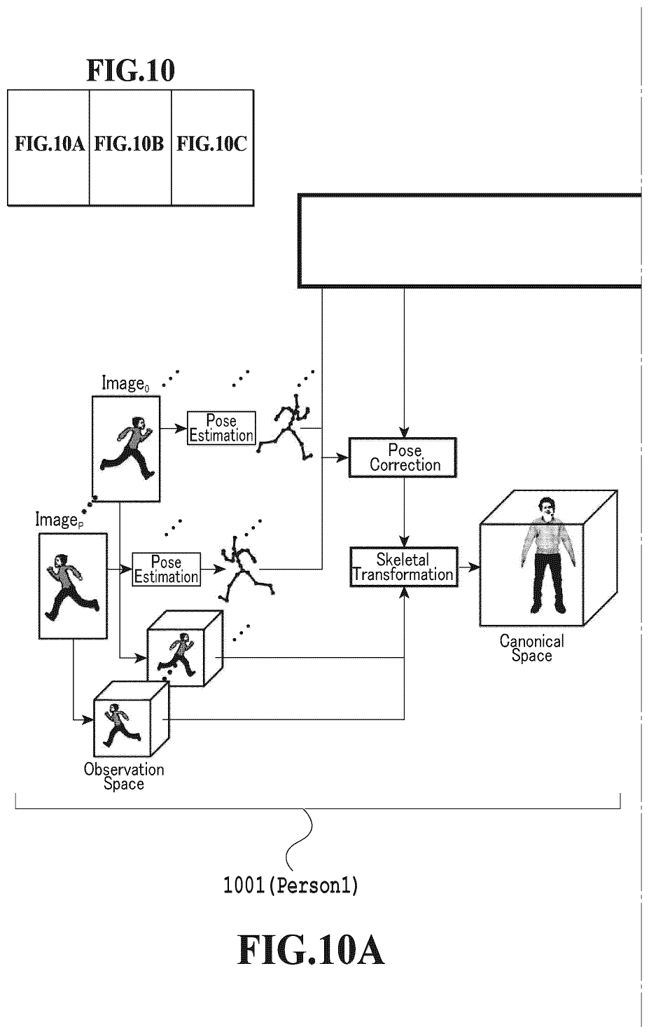

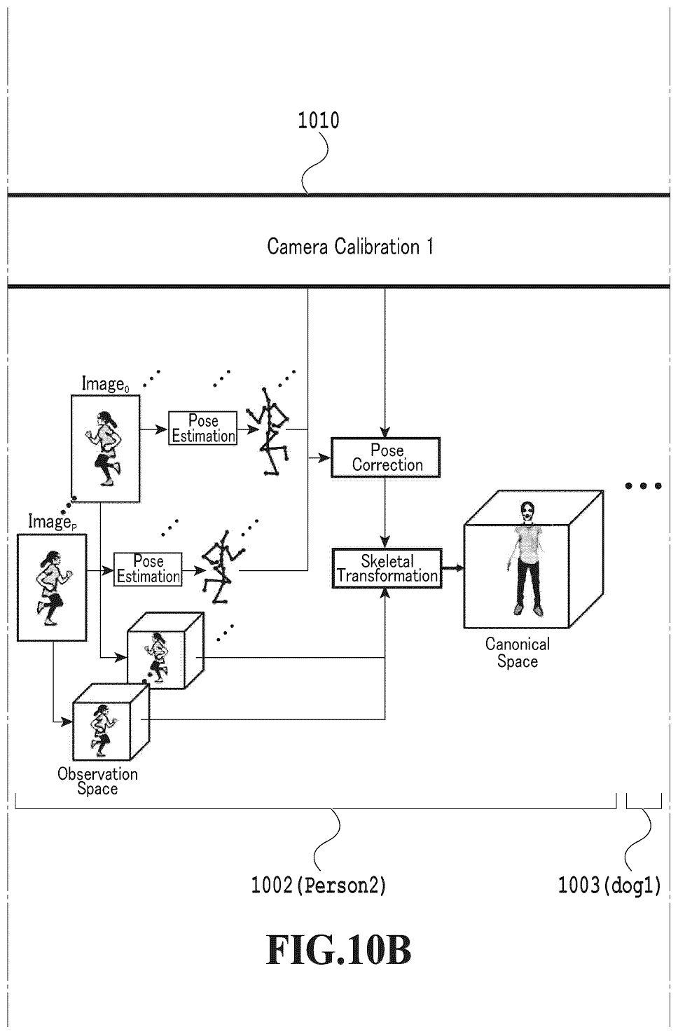

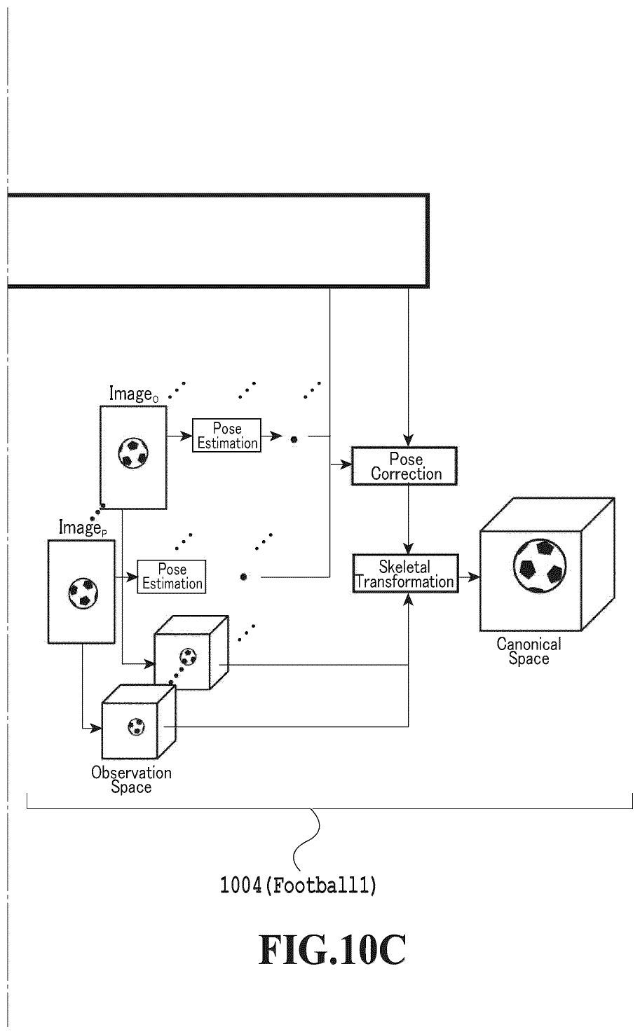

FIGS. 10A to 10C are image diagrams of the optimization calculation using spaces of the number of the instances detected in S802. Unlike FIGS. 5A and 5B, FIGS. 10A to 10C illustrates processing until the three-dimensional reconstruction results are integrated into the Canonical Space.

Unlike the first embodiment, in the present embodiment, in a case where there are multiple people as the image capturing target, it is necessary to perform the calculation for the number of people. Additionally, it is necessary to execute similar calculation also for the object other than the person, which is the animal or the non-living material. Therefore, the camera calibration 1 is executed by integrating the results of the skeleton estimation performed on the instances, and the camera parameter obtained as a result is the initial value for the camera calibration 2.

Additionally, in the three-dimensional reconstruction, since the Observation Space and the Canonical Space are defined and each calculation is executed, the spaces of the number of the instances detected in S802, that is, the number of the objects in the image capturing environment are necessary.

Processing from 1001 to 1004 indicates processing executed for each instance (object). Note that, the details of the processing 1003 are omitted from the illustration because of space limitation on the paper. It is described under the assumption that there is no difference between the processing from 1001 to 1004 in the instances as a matter of principle. As illustrated in FIGS. 10A to 10C, the Pose Correction executed in S812 and the conversion into the Canonical Space by executing the Skeletal Transformation executed in S814 is performed for each instance.

In FIGS. 10A to 10C, the skeleton information obtained from each of the four instances and camera calibration 1010 indicating the camera calibration 1 are connected to each other with a line. This indicates that the camera calibration 1 is executed with reference to the position information of the joint of each instance. In addition, the initial value of the camera parameter obtained as a result of the camera calibration 1 affects the Pose Correction and the like in all the processing from 1001 to 1004. As a result, the three-dimensional shape result expressed in the Canonical Space of each instance is updated. Additionally, although it is not illustrated in FIGS. 10A to 10C, in the processing of each instance, the inverse conversion from the Canonical Space into the Observation Space is performed, and the three-dimensional reconstruction result expressed in the Observation Space is obtained. The rendering loss F₂ indicating the error between the output image outputted from the three-dimensional reconstruction result expressed in the Observation Space and the input image as the correct answer image is calculated from each of the four instances.

Thus, in the present embodiment, it is necessary to calculate the rendering loss F₂ for each instance. In a case where the rendering loss ε₂ is calculated in one processing out of the processing from 1001 to 1004, the rendering loss ε₂ may be calculated by using the mask indicating the region of the instance detected in S802. Specifically, it is assumed that the target instance is the instance of Person1, and the correct answer image is the frame f. In this case, between the output image from the three-dimensional reconstruction result in the Observation Space and the frame f, the rendering loss ε₂ may be calculated by comparing differences in pixel values of only the region corresponding to the mask of the Person1 detected from the frame f. Thus, with only the region of the mask of the target instance being compared in the processing from 1001 to 1004 in each instance, it is possible to calculate the rendering loss ε₂ without utilizing the information of the region in which the target instance is covered.

Note that, likewise, the mask indicating the region of the object may be generated by excluding the background region from the captured image and the rendering loss ε₂ may be calculated by using the mask also in the first embodiment, for example.

Additionally, in a case where the total loss and the threshold τ are compared in S816, the total loss may be obtained by adding up the loss ε₁ and the loss ε₂ calculated in the processing from 1001 to 1004 in each instance. In this case, the total sum of the loss ε₁ and the loss ε₂ considering the weight may be calculated by determining the weight based on the instance.

As described above, in the present embodiment, it is described that the skeleton estimation of the person and the animal and the position estimation of a general object are executed to execute the camera calibration from the images obtained by the synchronized image capturing performed by the small number of, about two or three, cameras. Thus, in the present embodiment, the posture of the person and the position of the object are stably obtained, each object is individually recognized and tracked, and the three-dimensional reconstruction is performed independently. As an effect thereof, it is possible to provide an application that performs display that cannot be implemented with a method of the three-dimensional reconstruction of the entire scene with reference to only the information of the multiple cameras observed at the same time as the NeRF in Non-Patent Literature 3.

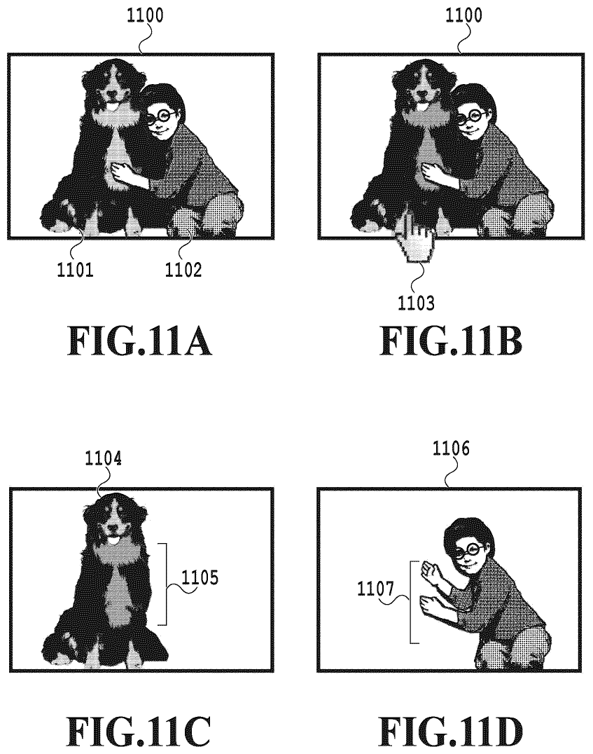

FIG. 11A is a diagram illustrating an example of a screen 1100 displayed on the display unit 306 by the CPU 301. On the screen 1100, an image obtained by the rendering to show an image viewed from an arbitrary testing viewpoint by using the three-dimensional reconstruction result of each instance (object) obtained in S807 is displayed. On the screen 1100 in FIG. 11A, a dog 1101 and a person 1102 as the target of the three-dimensional reconstruction are drawn, and the dog 1101 and the person 1102 are closely attached to each other. In a case where the user wants to see the image of only an arbitrary object, in the present embodiment, the user can select the object as a target of the rendering by using a pointer 1103 illustrated in FIG. 11B. In the present embodiment, in S802, the instance ID is applied to the target object of the three-dimensional reconstruction, and in S807, the three-dimensional reconstruction is performed for each instance, and as a result, the three-dimensional reconstruction result for each object is obtained. Therefore, it is possible to accept the selection of the target object of the rendering from the user.

FIG. 11C is a diagram illustrating an example of a screen 1104 in a case where the dog 1101 is selected and the rendering is performed by using the three-dimensional reconstruction result of the dog 1101. FIG. 11D is a diagram illustrating an example of a screen 1106 in a case where the person 1102 is selected and the rendering is performed. As illustrated in the screen 1100 in FIG. 11A, in a case where the dog 1101 and the person 1102 are closely attached to each other, the rendering results of regions 1105 and 1107 by the method by the NeRF in Non-Patent Literature 3 or a method by a classical visual hull are indefinite. Therefore, in the method by the NeRF in Non-Patent Literature 3 or the classical method, in a case of trying to generate the image shown on the screen in FIG. 11C or FIG. 11D, the image with deteriorated quality is generated. On the other hand, according to the present embodiment, the three-dimensional reconstruction results obtained by observing across the multiple frames are integrated. Therefore, it is also possible to reproduce the region that is not observed from the camera in a case of selecting the target object of the rendering by utilizing the information observed at another time. Therefore, according to the present embodiment, it is possible to display the screen of the object with a suppressed deterioration level. The above-described utilization method is helpful in, for example, a case where a sports scene of soccer, rugby, and so on is image-captured, a case where detailed observation of only the movement a particular person is desired, and the like.

Additionally, in the example in FIG. 7A, the joint position indicated by the skeleton information of each object is obtained with high accuracy. Therefore, after the three-dimensional reconstruction is executed, it is also possible to set the virtual viewpoint to the joint position of the top of the head of the dog 704 so as to obtain a viewpoint from the dog 704 and to output a virtual viewpoint video obtained by the rendering based on this virtual viewpoint. Thus, it is unnecessary to attach an actual camera as an actual object to a pet or to attach a marker such as the chessboard, and the labor of the user for the image capturing is suppressed. Likewise, it is also possible to output the virtual viewpoint video from the viewpoints of the two children, which are the person 701 and the person 703, and the virtual viewpoint video from the viewpoint of looking down from the ball.

As described above, according to the present embodiment, even with the video obtained by the image capturing in the image capturing environment in which the object is covered with the other object frequently, it is possible to extract the object from the video correctly and to perform the three-dimensional reconstruction. Therefore, it is possible to provide the video rendered from various viewpoints.

### Third Embodiment

In the first embodiment and the second embodiment, it is described that the images of the image capturing target are captured by the synchronized multiple cameras. In the present embodiment, a method of processing the camera calibration and the three-dimensional reconstruction without the image capturing at strictly matching image capturing times by the small number of cameras, about two to three, is described. As for the present embodiment, a difference from the first embodiment is mainly described. A portion that is not particularly described is the same configuration and processing as that of the first embodiment.

As with the second embodiment, multiple image capturing targets may be applied; however, for the sake of simplicity, it is assumed that the images of the single target person 11 are captured as with the first embodiment. Therefore, it is described under the assumption that the setting of the image capturing environment and the like in the present embodiment is the same as that in the first embodiment except the point that the two cameras do not perform the image capturing in synchronization.

### [System Configuration]

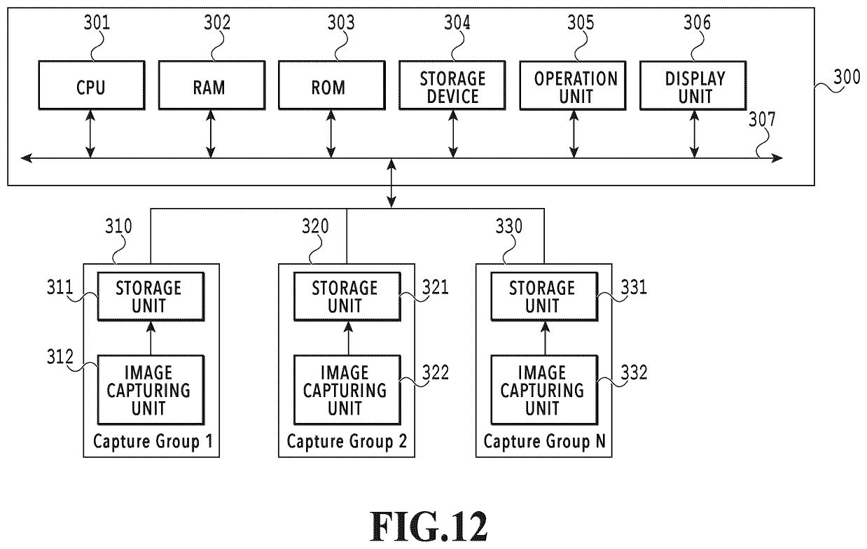

FIG. 12 is a diagram describing apparatuses included in a system according to the present embodiment and a hardware configuration of each apparatus. The same configuration as that of FIG. 3 is provided with the same reference numeral. A difference from FIG. 3 is that FIG. 12 does not include the clock generator 340. Therefore, the image capturing units 312, 322, and 332 of the capture groups 310, 320, and 330 in the present embodiment perform the image capturing without synchronization. The information processing apparatus 300 receives the corresponding captured images obtained from the results of the image capturing. Then, after receiving the captured images, the information processing apparatus 300 in the present embodiment performs the synchronization with reference to the image capturing times applied to the received captured images and stores the captured images. In addition, the information processing apparatus 300 in the present embodiment uses the stored captured images to execute the camera calibration and the three-dimensional reconstruction.

Although the synchronized image capturing by the image capturing units 312, 322, and 332 is unnecessary, the times of the capturing the images of the same target in the image capturing by the image capturing units 312, 322, and 332 need to overlap. A case where three videographers operating the capture groups 310, 320, and 330 press an image capturing start switch in each of the capture groups 310, 320, and 330 at a signal and the image capturing units 312, 322, and 332 each start the image capturing is expected. Additionally, in a case as illustrated in FIG. 1A, it is expected that the videographer 10 using the camera 13 and the videographer 12 using the camera 16 each capture the images at the same timings such that they start the image capturing at the beginning of the performance of the target person 11 and they end the image capturing at the ending of the performance. Therefore, although the image capturing start time and the image capturing end time substantially match between the multiple cameras, it is impossible to capture the images of the posture of the target person at the exact same timing in a case where the target person 11 moves around.

[about Camera Calibration and Three-Dimensional Reconstruction]

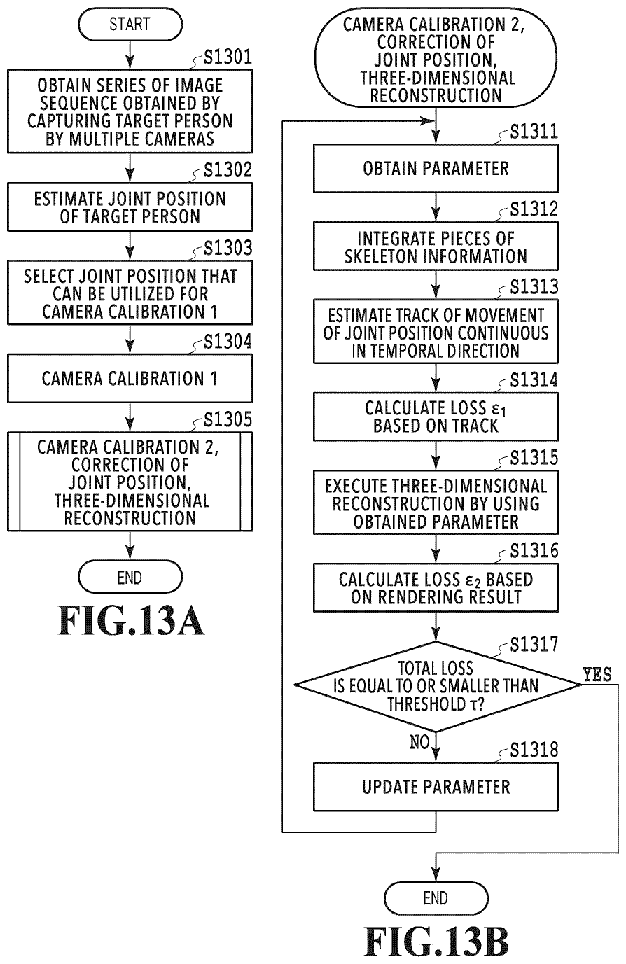

FIGS. 13A and 13B are flowcharts describing a flow of the processing of the camera calibration and the three-dimensional reconstruction in the present embodiment. A series of steps illustrated in the flowcharts in FIGS. 13A and 13B are performed with the CPU 301 of the information processing apparatus 300 in the present embodiment deploying the program code stored in the ROM 303 to the RAM 302 to execute. Additionally, a part of or all the functions of the steps in FIGS. 13A and 13B may be implemented by hardware such as an ASIC and an electronic circuit.

For the sake of simplifying the description, in the present embodiment, it is assumed that the internal camera parameter of the camera is fixedly obtained in advance. Therefore, in the description of FIGS. 13A and 13B, it is assumed that the parameter related to the camera obtained by the camera calibration relates to the external camera parameter.

In the flowcharts in FIGS. 13A and 13B, a case where each of the small number of, two or three, capture groups captures the images of the single person for about a few minutes in the temporal direction is expected. Therefore, as the description of the flowcharts in FIGS. 13A and 13B, it is described under the assumption that the two cameras 13 and 16 that are the two capture groups capture the images of the target person 11 as illustrated in FIG. 1A. Although the minimum set of the number of the cameras in the present embodiment is two, the number may be three or more. Additionally, it is described under the assumption that the cameras 13 and 16 capture the images while the position and the orientation are fixed. Moreover, in the present embodiment, as described above, strict matching of the image capturing times of the image capturing by the cameras 13 and 16 is unnecessary.

In S1301, the CPU 301 receives the movie (the video) including the target person 11 that is obtained with the cameras 13 and 16 capturing the images of the target person 11. The movie is images (an image sequence) including the multiple frames. In a case where the images of the image capturing target such as the target person 11 are captured continuously in the temporal direction, it is necessary to capture the images by the multiple cameras 13 and 16 in the same time period. However, unlike the first embodiment, the times at which the multiple cameras 13 and 16 capture the images of the image capturing target, such as timings of pressing a shutter for continuous image capturing, do not need to match.

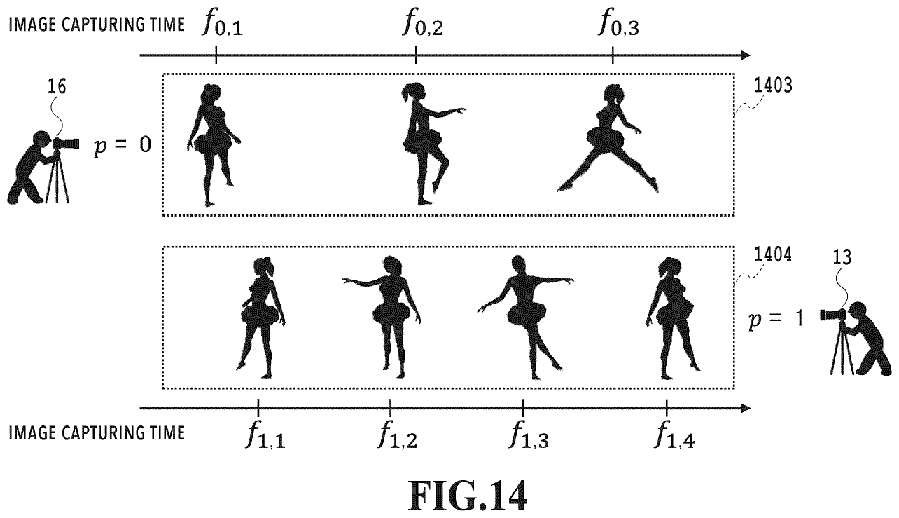

FIG. 14 is a diagram schematically illustrating a state in which the timings of capturing the images do not match even in a case where the two cameras capture the images simultaneously. An upper diagram 1403 in FIG. 14 illustrates the captured image (the frame) for each time at which the camera 13 in FIG. 1A captures the image, and a lower diagram 1404 illustrates the captured image (the frame) for each time at which the camera 16 in FIG. 1A captures the image. A frame rate (fps) of the image capturing speed of each of the cameras 13 and 16 is different, and the cameras 13 and 16 are capturing frames at different timings. Therefore, FIG. 14 illustrates that the posture of the target person 11 in the image capturing by the camera 13 and the posture of the target person 11 in the image capturing by the camera 16 are different.

As with the first embodiment, it is assumed that the camera ID in a case where the P cameras capture the images is distinguished as p (0≤p<P), and the frame f (0≤f<F) of the captured image distinguishes which camera p is basically used to capture the frame. In FIG. 14, the correspondence between the camera p and the frame f is illustrated. The camera ID of the camera 16 is p=0, and it is indicated that the target person 11 image-captured by the camera 16 is image-captured at times f_{0, 1}, f_{0, 2}, and f_{0, 3}. The camera ID of the camera 13 is p=1, and it is indicated that the target person 11 image-captured by the camera 13 is image-captured at times f_{1, 1}, f_{1, 2}, f_{1, 3}, and f_{1, 4}. Thus, since the cameras 13 and 16 do not capture the images at the same time, the frame f is expressed as f_{p, f} by applying the camera ID in front of the frame ID indicating the image capturing order. Even in a case where the image capturing timings of different cameras match by coincidence in the actual environment, it is unnecessary to change the processing flow of the present embodiment.

In S1301, the CPU 301 receives the captured image groups continuous in the temporal direction from each of the cameras 13 and 16 after the image capturing by the cameras 13 and 16 start. In the present embodiment, unlike the first embodiment, the image capturing timings and the frame rates (fps) of the image capturing speed of the cameras 13 and 16 are different. Therefore, the number of the captured images obtained by the CPU 301 may be different between the cameras 13 and 16.

The captured image groups obtained by the image capturing by the cameras 13 and 16 are preferably captured image groups with substantially matching image capturing start times and substantially matching the image capturing end times. Therefore, the captured image groups obtained by the CPU 301 in S1301 may be captured image groups that are associated by only determining that the images are captured in approximately close time periods based on the captured image groups to which imprecise time codes that are out of synchronization are applied.

Alternatively, without referring to the time codes, the user who knows that the images of the same target person 11 are captured in approximately the same time period may select a set the image sequences obtained by the image capturing by the multiple cameras 13 and 16 after the image capturing and may input to the information processing apparatus 300. In the present flowchart, it is described that the two cameras 13 and 16 capture the images of the performance of the same target person 11 from the beginning to the end. In this case, it is easy to associate the image sequences obtained by the image capturing of the target person of the three-dimensional reconstruction by the multiple cameras in similar time periods.

In S1302, the CPU 301 executes the skeleton estimation on the series of image sequence obtained by the image capturing by each of the cameras 13 and 16. Since it is possible to execute the skeleton estimation method as with the first embodiment, description is omitted. Also in the present embodiment, as with the first embodiment, it is assumed that each joint position has the estimation likelihood.

Architecture diagrams to describe the processing of the flowcharts in FIGS. 13A and 13B are illustrated in FIGS. 5A and 5B as with the first embodiment. The input image 500 as the Image 0 is the image obtained by the image capturing by the camera 16. The input image 501 as the Image 1 indicates the image obtained by the image capturing by the camera 13. The input images 500 and 501 are received in S1301. In the first embodiment, the posture estimation (the skeleton estimation) of the person is executed on each of the input images with the same time code or the time codes having a difference equal to or less than the predetermined value to assume that the same points are observed and associate the points, and thus the camera calibration 1 is executed. Any definition may be applicable for the skeleton estimated in the present embodiment, and in this case, as with the first embodiment, it is assumed that the skeleton definition of the human body exemplified in FIG. 6 is used.

In the present embodiment, the cameras 13 and 16 do not capture the images of the target person 11 at the same time; for this reason, it is impossible to associate the image captured by the camera 13 with the image captured by the camera 16 only with reference to the time codes. Therefore, it is impossible to perform the camera calibration based on only the skeleton estimated from the single frame as executed in the first embodiment. Therefore, the series of image sequence of the target on which the CPU 301 executes the skeleton estimation may be the entire image sequence captured by the user using each of the cameras 13 and 16 within a predetermined period of time. Alternatively, it may be an image sequence between the operation start time and end time of the three-dimensional reconstruction target that are designated and inputted by a GUI or the like by the user.

In S1303, the CPU 301 identifies the joint point that can be utilized for the camera calibration 1 utilizing the joint position of the estimated skeleton. Since the joint point preferable for the utilization in the camera calibration 1 is the joint point in the joint position that is still for most of a particular period of time, it is assumed that such a joint point is identified in S1303.

For example, it is possible to treat joint positional coordinates of a right foot joint position (R_FOOT) in FIG. 6 estimated from a walking person as a substantially still object from when the right foot touches the ground to when the foot steps in a traveling direction and moves away from the ground. Even in a case where there is a gap between the image capturing times of the multiple cameras 13 and 16, there is the joint position that is still for a longer period of time than the gap between the image capturing times. Therefore, in S1303, such a joint position may be identified. For example, out of the captured image groups obtained by the image capturing by the different p cameras, the frame sets with the applied time codes that are different by a predetermined threshold ζ (for example ζ=1.0 sec or the like) or less, which is defined in advance, are extracted. Then, out of the extracted frame sets, only the joint point with a movement distance of the estimated joint position in the frames adjacent in the temporal direction that is equal to or smaller than a predetermined threshold η (for example, η=three pixels or less or the like), which is defined in advance, is identified.

In S1304, the CPU 301 executes the camera calibration 1 as with S403 in the first embodiment. A difference from the first embodiment is that the joint point utilized in the camera calibration 1 is the joint point identified in S1303, and there is a possibility that the errors are increased to some degree depending on the selection criteria. However, since it is enough to execute the camera calibration at a rough level in the camera calibration 1, the calibration 1 may be executed in the same procedure as that in S403 also in S1304.

In S1305, the camera calibration 2 aiming a similar effect as that of S404 in the first embodiment is executed.

FIG. 13B is a flowchart illustrating details of S1305.

In S1311, the CPU 301 obtains the camera parameter derived as a result of the camera calibration 1 in S1304 and the parameter indicating the joint position of the human body derived as a result of S1302 as the initial value. Alternatively, in a case where the parameter is updated in S1318 because the later-described total loss exceeds the threshold τ in S1317, in S1311, the CPU 301 obtains the camera parameter and the parameter of the joint position after the update.

In S1312, with a similar method as that in S412, the CPU 301 converts the position information of each joint in the corresponding camera coordinates estimated from each of the input images into the position information in the world coordinates by using the external camera parameter obtained in S1311. Then, the CPU 301 integrates the skeleton information. That is, the single piece of skeleton information indicating the position of each joint of the object in the three-dimensional world coordinates is generated. It is assumed that the integration of the present skeleton information is also performed similarly as that in S412. Therefore, a configuration in which X_{j,f} corrected as a result of the integration is passed to the Skeletal Transformation 510 in FIGS. 5A and 5B in S1315 and S1316 is applied.

In the first embodiment, the camera calibration 2 is executed under the assumption that the images of the target person 11 are captured by the multiple cameras in temporal synchronization and the estimated joint positions are ideally observed in the same point on the world coordinates. In the present embodiment, it is impossible to execute the camera calibration 2 without changing the estimated joint position. Therefore, in the present embodiment, as the loss ε₁ out of the losses considered as the optimization target, a loss based on the track indicating the movement of the position of the estimated joint point is defined. In the first embodiment, a method of reflecting the right or wrong of the position orientation of the camera to the score by formulating the reprojection error minimization as the maximum likelihood estimation problem and assuming that it is possible to approximate the estimation results of the joint position on the two-dimensional coordinates with the normal distribution of the standard deviation σ and setting a difference from the reprojection joint as the loss ε₁ is described. In the present embodiment, basically, there is no joint positions in the same three-dimensional point. Therefore, in the present embodiment, each track of the movement of the joint point that normally should be the same between the multiple cameras is derived, and a distance between the tracks is defined to evaluate a difference distance between the tracks as the loss ε₁.

Therefore, first, in S1313, the CPU 301 estimates the track indicating the movement of the position of the joint point of the human body skeleton continuous in the inputted temporal image sequence for each camera. Since the 17 joints are estimated for each frame for each human body as the three-dimensional reconstruction target, the tracks of 17 joint points are estimated for each camera in the sequence continuous in the temporal direction.

The camera 13 captures the images of the target person 11 continuously in the temporal direction, the human body skeleton estimation is performed on each of the captured image groups that are the multiple frames obtained by the image capturing, and estimated positional coordinates of only the position of a joint point PELVIS is plotted on the three-dimensional space. Then, it is assumed that, based on the plotted discrete positions of the joint point PELVIS, the track (trajectory) that is temporal transition of the position of the joint point PELVIS is estimated.

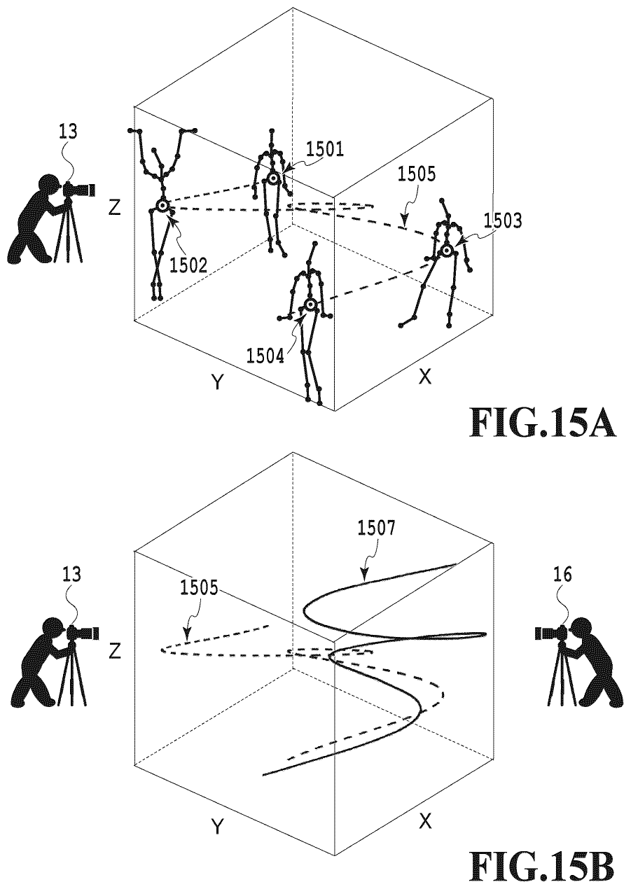

FIG. 15A illustrates a track 1505 by a broken line, which is the movement of the joint point PELVIS estimated from the captured images of the camera 13. A start point 1501 of the broken line is a point estimated as the position of the joint point PELVIS of the target person 11 in the captured image at the beginning of the image capturing. An end point 1504 of the broken line is a point estimated as the position of the joint point PELVIS of the target person 11 in the captured image at the ending of the image capturing. Additionally, a point 1502 and a point 1503 are points estimated as the positions of the joint point PELVIS of the target person 11 in the captured images between the start point 1501 and the end point 1504. In FIG. 15A, for the sake of viewability and clarity, an example in which the human body skeleton estimation is executed four times from the beginning of the image capturing to the ending of the image capturing is illustrated. As a matter of course, it is possible to obtain a better estimation result of the track of the joint point by executing the human body skeleton estimation many times with short image capturing intervals.

FIG. 15B is a diagram illustrating both the track 1505 of the movement of the joint point PELVIS estimated from the captured images of the camera 13 and a track 1507 of the movement of the joint point PELVIS estimated from the captured images of the other camera 16. Even in a case where there are a gap between the image capturing start times and a gap between the image capturing end times between the two cameras 13 and 16, as described above, the two cameras 13 and 16 capture the images of the performance of the same target person 11 from the beginning to the end. Therefore, normally, almost all the portions of the two tracks 1505 and 1507 in the same joint point should match on the world coordinates. However, in the initial stage, each of the cameras 13 and 16 individually executes the track estimation. Therefore, as illustrated in FIG. 15B, a difference occurs between the track 1505 and the track 1507 of the same joint point PELVIS.

Normally, the tracks of the joint points estimated from the movements of the same joint position (for example, PELVIS in FIG. 6) within a predetermined period of time that is estimated from the multiple cameras should completely match on the world coordinates. Accordingly, based on the joint position in a single frame, it is difficult to execute the camera calibration 2 by using different positions in a case where the image capturing time do not match. However, in a case where it is possible to accurately estimate the movement trajectory of the three-dimensional point by tracking the discretely observed joint positions in the temporal direction, it is possible to perform the camera calibration 2 based on the track of the joint point. The difference between the tracks 1505 and 1507 of the same joint point initially estimated in S1313 can be made small by estimating the camera parameter representing the position orientation of the camera to make it close to a correct value.

Next, as a specific estimation method of the track of the joint point, a method of estimating the track from the multiple discrete joint positions of the skeleton displaced continuously in the temporal direction that are estimated from the captured images at different image capturing times by the cameras is described. The estimation method of the track of the joint point is, for example, executed by an algorithm that reconstructs a three-dimensional track from a movement point in two-dimensional perspective projection. In this case, based on the positions of the discrete estimated joint points, each track is expressed by linear coupling of compact track basis functions. In this case, it is assumed that a track coefficient vector by a linear least-squares method is solved.

As with the first embodiment, here, a specific internal camera parameter calibrated in advance in already-known each camera p (0≤p<P) is described as K^{p}. Additionally, the position and the orientation of the camera are represented by using R^{p} and t^{p}, and an object is to estimate the parameter set <R^{p}, t^{p}>. In addition, a method of describing a sign used in the Mathematical Expression is also equivalent to the first embodiment.

Additionally, as with the first embodiment, the error is calculated for the optimization target parameters K^{p}, R^{p}, t^{p}, and X, and a problem of estimating the continuously changing track from the discrete skeleton joint positions estimated with the conditions of each optimization target parameter is solved. The estimation of the track is processing that is executed to define the error as the distance and can be executed also by any method as long as it is possible to calculate the distance that can be optimized.

Out of the captured images obtained by the image capturing by the camera p, the position of the joint j in the three-dimensional world coordinates estimated from the frame f and the position of the joint j on the three-dimensional coordinates in the camera coordinate system of the camera p are as defined by the Mathematical Expression 1. As described above, f in the Mathematical Expression 1 is the parameter related to p. Additionally, likewise, in a case where it is assumed that the position of the joint j is represented by x^{p}_{j, f} on the two-dimensional image, in the camera p, a relationship between the position x^{p}_{j, f} of the joint j on the two-dimensional image and the position X^{p}_{j, f} of the joint j on the original three-dimensional coordinates can be expressed by the Mathematical Expression 2.

There is a point group obtained by tracking the estimated joint points j in the temporal direction, and a set of the three-dimensional tracks is derived from the estimated points by a method described below. It is assumed that the three-dimensional track derived herein is represented by G(j), and this structure is defined as Mathematical Expression 14. The Mathematical Expression 14 is not a definitional expression of the three-dimensional tracks different depending on the cameras but is a definitional expression of the three-dimensional tracks that match between all the cameras and should be obtained. Therefore, the expression 14 is described so as not to include p, which is the camera ID.

$$G ( j ) = {[ \begin{matrix}{{G}_{0} ( j )}^{T} & {G}_{1} {( j )}^{T} & {G}_{2} {( j )}^{T}\end{matrix} ]}^{T} \qquad [ Mathematical Expression 14 ]$$

$$where {G}_{0} ( j ) = {[ {X}_{0 , j , 0} , … , {X}_{0 , j , F - 1} ]}^{T} , {G}_{1} ( i ) = {[ {X}_{1 , j , 0} , … , {X}_{1 , j , F - 1} ]}^{T} , {G}_{2} ( i ) = {[ {X}_{2 , j , 0} , … , {X}_{2 , j , F - 1} ]}^{T}$$

X_{0, j, f} represents the positional coordinates in x coordinates on the three-dimensional coordinates in a case of the joint ID of j and the frame f (0≤f<F). X_{1, j, f} represents the positional coordinates in y coordinates on the three-dimensional coordinates in a case of the joint ID of j and the frame f. X_{2, j, f} represents the positional coordinates in Z coordinates on the three-dimensional coordinates in a case of the joint ID of j and the frame f.

Next, the points on the three-dimensional coordinates estimated by using the expression 14 are divided into a point group set for each camera p, and the approximate calculation of the tracks of the joint point inferred from the cameras p is performed. The track of the joint point corresponding to each camera is linear coupling of the basis track used for the approximate calculation, and the tracks of each joint point of the P cameras are obtained by using Mathematical Expression 15.

$$( p , j ) = {\sum }_{i = 1}^{k} {a}_{0 , i} ( p , j ) {θ}^{i} , ( p , j ) = {\sum }_{i = 1}^{k} {a}_{1 , i} ( p , j ) {θ}^{i} , ( j ) = {\sum }_{i = 1}^{k} {a}_{2 , i} ( p , j ) {θ}^{i} \qquad [ Mathematical Expression 15 ]$$

θⁱεR^{F} is a track basis vector.

[symbol] (p,j) is also described as Gₙ\hat{ }(p,j).

Here, a_{0, i}(p, j), a_{1, i}(p, j), and a_{2, i}(p, j) each represent a coefficient of the corresponding basis vector. The expression 15 expresses G₀\hat{ }(p, j), G₁\hat{ }(p, j), and G₂\hat{ }(p, j) as linear coupling of the k basis tracks that are defined in advance. In a case of defining as the Mathematical Expression 15, as the track basis vector, it is possible to perform the calculation by using, for example, a method using a discrete Fourier transform (DCT) basis defined in advance, a discrete wavelet transform (DWT) basis, and a Hadamard transform basis.

The estimation error of the track of each joint point estimated for each camera p is minimized by using the track basis vector exemplified as described above, and thereby the error of the three-dimensional track inferred from the joint point estimated from the captured images of each camera is corrected. In a case of the two cameras, it is possible to achieve the object by the optimization method to minimize the estimation error of the track of each joint point estimated from the two cameras, which are p=0 and P=1. Therefore, with the track of each joint point described as the Mathematical Expression 15, it is possible to express each coordinate with the k parameters, and it is possible to calculate the error between the estimated tracks by the cameras. In this case, the total number k of the bases is achieved by determining a predetermined number in advance.

In S1314, the CPU 301 calculates the loss ε₁ calculated based on the track of the movement of each joint position. In the present embodiment, the loss ε₁ based on the track for the optimization of K^{p}, R^{p}, t^{p}, and X is calculated while correcting the estimated track of the joint point.

It is assumed that the optimization of the tracks of three types of varied tracks in the three axis directions, X, Y, and Z, with respect to a temporal direction component fₚ listed in the Mathematical Expression 15 is executed. In a case of the two cameras, the track of the joint point observed by the camera of p=0 and the track of the joint point observed by the camera of p=1 are normally tracks obtained by tracking the position of the same joint point. Therefore, since the tracks of the joint points estimated from the captured images of the corresponding cameras need to match on the world coordinates, the optimization is performed to reduce the difference between the estimated tracks and make close to the track that is normally desired to be obtained.

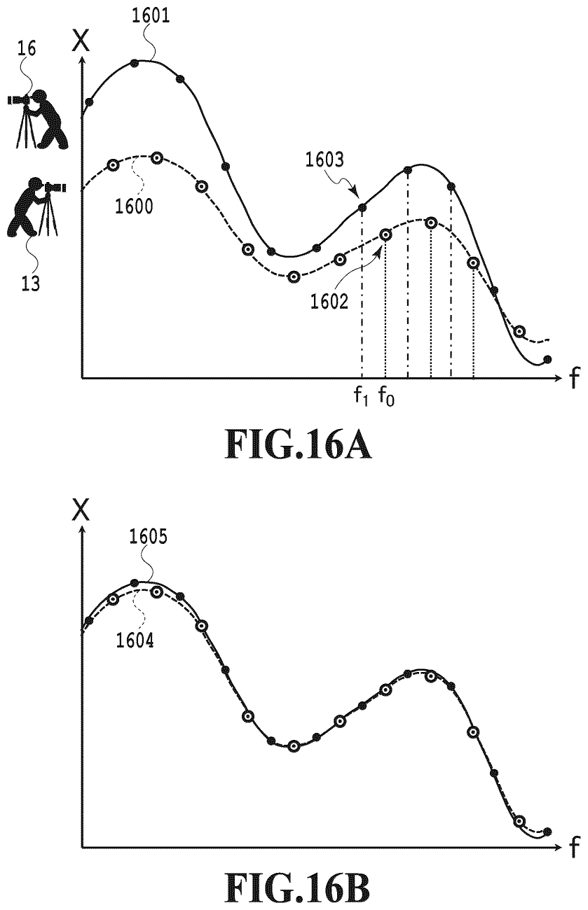

FIG. 16A is a diagram illustrating estimated displacement of the joint j in an X axis direction with respect to the temporal direction component f. In FIG. 16A, displacement 1600 of the track in the X axis direction related to f estimated from the camera 13 of p=1 and displacement 1601 of the track in the X axis direction related to f estimated from the camera 16 of p=0 are drawn. The displacement 1600 is a diagram drawn based on the displacement of the estimated track 1505 in the three-dimensional space in FIG. 15B in the X axis direction with respect to the temporal direction component f. The displacement 1601 is a diagram drawn based on the displacement of the estimated track 1507 in the three-dimensional space in FIG. 15B in the X axis direction with respect to the temporal direction component f. In FIG. 16A, although the tracks are drawn while matching the positions of the tracks estimated from the corresponding cameras with respect to the temporal direction component f, since the image-captured timings of the cameras do not match, the positions of the plotting do not match. Therefore, for example, it is assumed that the points included in the displacement 1600 and the displacement 1601, respectively, at contiguous f are compared. The time of an image capturing point 1602 obtained by the camera 13 of p=1 is f₀, and the time of an image capturing point 1603 obtained by the camera 16 of p=0 is f₁. Therefore, FIG. 16A illustrates the track of the joint point estimated from the captured images in a case where the image capturing timings of the cameras are different.

As a matter of course, as with the track of the joint point on the three-dimension described above, even in a case of a displacement graph in the X axis direction with respect to the temporal direction component f, since it is normally the displacement on the X axis on the world coordinates estimated by the image capturing of the joint j of completely the same person by the cameras, the tracks should match. In the initial state, the two tracks do not match. Therefore, the distance between the tracks obtained by the cameras and each estimated for the joint j is represented by δ_{j, d} and defined as Mathematical Expression 16 to be calculated as the error, and the optimization calculation is executed to reduce the distance δ_{j, d}; thus, it is possible to roughly estimate the camera position orientation. As for an index d, d=0 represents the X axis, d=1 represents the Y axis, and d=2 represents the Z axis. That is, the optimization calculation to reduce a distance δ_{j, 0} on the X axis, a distance δ_{j, 1} on the Y axis, and a distance δ_{j, 2} on the Z axis is executed.

As an example of the easiest definition of the loss, the Mathematical Expression 16 is a squared loss of the difference between the tracks. Additionally, the X axis, the Y axis, and the Z axis are simply described as d=0, 1, 2. With the difference between the distances being obtained for all the joints j according to the Mathematical Expression 16, the loss ε₁ based on the current position orientation parameter of each camera and the positional coordinates of each joint estimated with the current parameter is defined in S1314.

$${ε}_{1} = {{\sum }^{P - 2}}_{p = 0} {{\sum }^{P - 1}}_{n = p + 1} {{\sum }^{J - 1}}_{j = 0} {{\sum }^{2}}_{d = 0} {\int }_{f = 0}^{F} {( ( p , j ) - ( n , j ) )}^{2} df \qquad [ Mathematical Expression 16 ]$$

With the utilization of a loss calculation result for the estimated track of the joint point, as with a case where the estimated positional coordinates of the joint are provided as described in the first embodiment, it is possible to obtain a better camera position orientation estimation result while updating the position orientation of the camera by repetitive processing. As a result, for example, as for the displacement 1600 and the displacement 1601 of the tracks that are obtained by the multiple cameras 13 and 16 and have the initial state as illustrated in FIG. 16A, it is possible to confirm a state of being converged as multiple contiguous curves as displacement 1604 and displacement 1605 of the tracks in FIG. 16B.

In S1315, the CPU 301 increases the accuracy of the camera position orientation with reference to the three-dimensional reconstruction result about the person while utilizing the position orientation of the camera as the initial value. S1315 and S1316 have the same flow as S414 and S415; for this reason, detailed descriptions are omitted. In S1315, the CPU 301 performs the three-dimensional reconstruction by using the camera parameter obtained in S1311. Then, in S1316, the CPU 301 calculates the rendering loss ε₂ defined by the Mathematical Expression 12. With the optimization based on the loss ε₂, it is possible to obtain the eventual camera calibration result and three-dimensional reconstruction result. Thereafter, the processing in S1305 ends in a case where the conditions are satisfied by comparing with the threshold T that is the termination conditions of the present optimization processing in S1317.

As described above, according to the present embodiment, even in a case where the images of the target person are captured by the small number of cameras without synchronization, it is possible to execute the accurate camera calibration by updating the estimation result of the camera position orientation while performing the three-dimensional reconstruction. As a result, it is possible to obtain a high quality three-dimensional reconstruction result.

Additionally, although a case where the image capturing target is the single person is described as an example in the present embodiment, it is needless to say that, it is possible to implement the embodiment even in a case of multiple targets or the target other than the person such as the animal and the non-living material by introducing the loss calculation method executed in the present embodiment to the processing flow of the second embodiment.

### Fourth Embodiment

The present embodiment is an embodiment as a modification of the third embodiment. The present embodiment is described mainly about a difference from the third embodiment. A portion that is not particularly described is the same configuration and processing as that of the third embodiment.

In the third embodiment, the continuous track of the joint point of the human body skeleton in the temporal image sequence inputted for each camera is estimated in S1313 while assuming the definition according to the Mathematical Expression 15. In the third embodiment, as the track basis vector expected, the calculation is performed by using the discrete Fourier transform (DCT) basis defined in advance, the discrete wavelet transform (DWT) basis, and the Hadamard transform basis. In the present embodiment, a method of using a gauss basis function instead of the track basis vector by redefining the Mathematical Expression 15 as Mathematical Expression 17 is described. With use of the Mathematical Expression 17, easier execution is possible, and it is possible to eliminate the effect of the estimated joint point with a great estimation error.

In the Mathematical Expression 17, in a case where the three-dimensional points varied in the temporal direction in the three-dimensional point track are divided into the X, Y, and Z axis components, the track is estimated by simplifying into a graph of a case where the temporal direction component is set as a horizontal axis. Note that, although the time code of the temporal direction component may be set as the horizontal axis, it is described as f of the frame ID.

$$( {f}_{p} ) = {\sum }_{i = 1}^{k} {a}_{p , j , 0}^{i} {θ}^{i} ( {f}_{p} ) , ( {f}_{p} ) = {\sum }_{i = 1}^{k} {a}_{p , j , 1}^{i} {θ}^{i} ( {f}_{p} ) , ( f ) = {\sum }_{i = 1}^{k} {a}_{p , j , 2}^{i} {θ}^{i} ( {f}_{p} ) \qquad [ Mathematical Expression 17 ]$$

Since a changed point caused by rewriting from the Mathematical Expression 15 to the Mathematical Expression 17 is the basis function related to the horizontal axis f, θⁱ that is the track basis vector that is already defined in advance in the Mathematical Expression 15 is changed to a function related to f that is represented by θⁱ(f) in the expression 17. Also in the Mathematical Expression 17, each track is obtained by providing the corresponding coefficients aⁱ_{p, j, 0} to the basis and overlapping the k bases. Also in the Mathematical Expression 17, it is necessary to define k in advance; however, since the track basis function related to f can be calculated for only the vicinity of the observed point, the number of the basis functions used for the estimation of the track related to the camera p is a subset of all fₚ (0≤fₚ<Fₚ). Fₚ is the total number of the images captured by the camera p. Therefore, as long as k<Fₚ is obtained, a number defined in advance according to 0≤k<Fₚ may be randomly selected as k. However, the estimation accuracy is improved by setting basically a great value. Therefore, here, a problem is to obtain aⁱ_{p,j, 0}, aⁱ_{p,j, 1}, and aⁱ_{r,j,2} that are all optimized by providing the gauss function on the horizontal axis to all fₚ corresponding to the inferred positional coordinates of the joint image-captured by the camera p. The estimation of the tracks of all the estimation target joint number is executed by the above method.

Subsequently, a procedure of calculating the loss based on the track for the optimization of K^{p}, R^{p}, t^{p}, and X while correcting the track estimated in S1313 by using the estimated track of the joint point is described. As with the third embodiment, the distance between the tracks each estimated for the joint j is represented by δ_{j, d}, and ε₁ is defined by Mathematical Expression 18 combining the displacement on the X axis, the displacement on the Y axis, and the displacement on the Z axis. Then, ε₁ defined by the Mathematical Expression 18 is calculated as the loss, and the optimization calculation to make the loss ε₁ small is executed. With this, it is possible to roughly estimate the camera position orientation. As an example of the easiest definition of the loss, the Mathematical Expression 18 is a squared loss of the difference between the tracks. Additionally, the X axis, the Y axis, and the Z axis are simply described as d=0, 1, 2.

With the difference between the distances being obtained for all the joints j according to the Mathematical Expression 18, the loss ε₁ based on the current position orientation parameter of each camera and the positional coordinate of each joint estimated with the current parameter is defined in S1314.

$${ε}_{1} = {{\sum }^{P - 2}}_{p = 0} {{\sum }^{P - 1}}_{n = p + 1} {{\sum }^{J - 1}}_{j = 0} {{\sum }^{2}}_{d = 0} {\int }_{f = 0}^{F} {( ( {f}_{p} ) - ( {f}_{n} ) )}^{2} df \qquad [ Mathematical Expression 18 ]$$

The loss ε₁ defined according to the Mathematical Expression 18 is in a form similar to that in the third embodiment. However, unlike the third embodiment, as defined by the Mathematical Expression 17, the track estimated as G_{p, j, 0}\hat{ }(fₚ) is formed of the k basis functions. Normally, there are a joint position that is quite close to the true value and a joint position that is not close to the true value as each joint position estimated at the moment of each image capturing. As also described in the description of the skeleton estimation, since each joint position has the estimation likelihood, it is possible to determine whether it is a reliable joint point based on the estimation likelihood.

In the present embodiment, unlike the third embodiment, since the directly estimated joint position is used for the track estimation, the basis function track estimation is performed for only the position with a high estimation likelihood without using the joint position with a low estimation likelihood, and thus it is possible to easily aim at an effect of avoiding the estimation of a wrong track. In addition, in some cases, the joint position is estimated at a position with a high estimation likelihood but away from the true value. For example, although the joint position at a hiding position that is not observed by the camera performing the image capturing is estimated as a position that is statistically probable, the actual posture may not be at the position. In this case, a method of excluding a wrong estimated joint position according to an index other than the likelihood outputted by the skeleton estimator is required. In this case, after the great difference between the tracks estimated by the k track basis functions by the different cameras is made small to make the tracks close to each other, a portion with a locally great difference is searched, and thus it is possible to accurately detect the estimated joint point that is an outlier.

It is assumed that there is great noise at the estimated joint position originated from a part of the track of the movement of a predetermined joint position in the temporal direction and this causes deterioration of the track estimation accuracy. The following processing is executed to identify the joint position in which the great noise is mixed. A score to determine the estimation error is defined as W (f_{p,j, d}). W (f_{p,j, d}) is defined by Mathematical Expression 19.

$$W ( {f}_{p , j , d} ) = {( ( {f}_{p} ) - ( {f}_{p + 1} ) )}^{2} , p = 0 , 1 , … P - 2 \qquad [ Mathematical Expression 19 ]$$

Eventually, it is possible to identify the point at which the joint position estimation is wrong with reference to the score W (f_{p, j, d}) in a case of searching for the point at which the error is not reduced by the optimization to minimize the loss ε₁. That is, the point at which the score W (f_{p,j, d}) is high is assumed as the wrong point, and f_{p,j, d} of the basis function at the point with the high score is excluded as the outlier. For example, the estimated joint position at which the score W (f_{p,j, d}) exceeds a predetermined threshold is eliminated so as not to be used for the track estimation, and the loss ε₁ is calculated again. The joint point on the track estimated after the wrong point is eliminated is assumed as a correct joint position, and thus it is possible to perform the estimation close to the true value. Thus, with the processing, it is possible to execute the estimation of the track at the joint point with higher reliability in S1314, and as a result, it is possible to determine so as not to utilize the wrong orientation in the three-dimensional reconstruction. With the utilization of the loss calculation result for the estimated track of the joint point, as with a case where the estimated positional coordinates of the joint are provided as described in the first embodiment, it is possible to obtain a better camera position orientation estimation result while updating the position orientation of the camera by the repetitive processing. A processing flow in and after S1315 is similar to that in the third embodiment.

As described above, according to the present embodiment, it is possible to easily execute the estimation of the track indicating the temporal direction of the joint position of the person by the unsynchronized image capturing. Additionally, it is possible to obtain a high quality three-dimensional reconstruction result while executing the accurate camera calibration.

### Fifth Embodiment

The present embodiment is a modification of the third embodiment and the fourth embodiment. In the above-described embodiment, a method of executing the camera calibration and the three-dimensional reconstruction simultaneously by using only the captured images without executing a camera calibration step using the fixed pattern in a case where the images are captured by the small number of cameras having a few common visual fields is described. Additionally, in the third embodiment and the fourth embodiment, a method of executing the camera calibration accurately even in a case where the image capturing is performed continuously in the temporal direction at different timings of the image capturing in a case of the image capturing by about two to three cameras is described. In the present embodiment, a method of executing good three-dimensional reconstruction also in a sports scene and the like in which the three-dimensional reconstruction target moves fast is described.

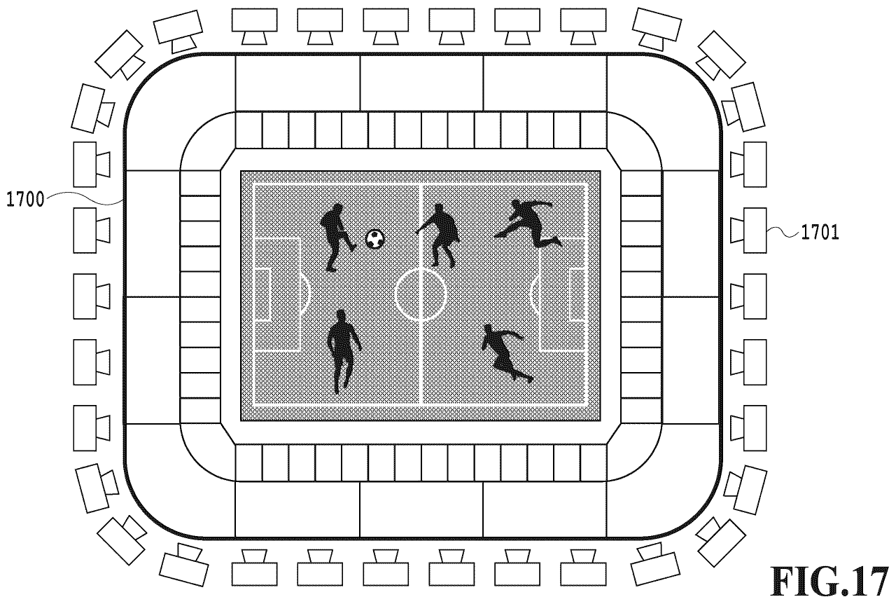

FIG. 17 is a diagram illustrating a soccer stadium. There is a case where the three-dimensional reconstruction of contents of a sport played in a place as illustrated in FIG. 17 is desired. In this case, for example, it is possible to consider that the visual hull is utilized to perform the three-dimensional reconstruction of the object such as a person in the stadium. In a case where the three-dimensional shape reconstruction of the object is performed by the visual hull, the three-dimensional shape is estimated based on a common region of a viewing volume indicated by a silhouette of the three-dimensional shape reconstruction target object in each camera. In order to perform the accurate three-dimensional estimation by the visual hull, it has been necessary to capture the images by all the cameras 1701 installed in the stadium at the same time. Therefore, even in a case where the three-dimensional reconstruction of the contents of the sport played in the place as illustrated in FIG. 17 is desired, a good three-dimensional reconstruction result is obtained even with the different image capturing times by introducing the method of the third embodiment and the fourth embodiment.

In addition, in a method like the Visual Hull, it is necessary to execute the thorough camera calibration before the match starts, and thus thereafter it is necessary to capture the images with completely no motion of the position orientation of the camera. Therefore, in a case where an interesting scene as a replay target occurs during broadcast on TV and the like in a process of the match being played, if there are a small number of cameras capturing the images of the region in which the scene occurs at high resolution, there is a possibility that a good three-dimensional reconstruction of the scene cannot be obtained. Therefore, it is also possible to consider that the space in which the three-dimensional reconstruction can be performed is determined in advance as only a few places within a wide space, and only the play that occurs within the space is set as the target of the three-dimensional reconstruction. There is also a need of setting various spaces as the target of the three-dimensional reconstruction by moving the cameras for the image capturing according to the process of the match without using a fixed camera.

In a case where the images are captured by an oscillating camera while tracking the image capturing target constantly, it is necessary to execute the camera calibration dynamically for the image-captured scene every time. In a case where the images of only the soccer field are captured at high resolution, it is usually difficult to perform the camera calibration using a natural feature derived from a still object. Therefore, the camera calibration and the three-dimensional reconstruction may be executed with the beginning of the image capturing of the interesting scene by executing the camera calibration using the skeleton estimation result of the human body according to the above-described embodiment.

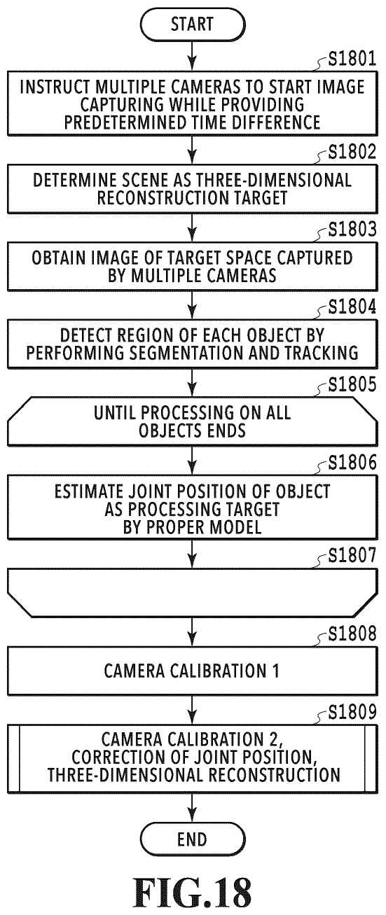

FIG. 18 is a flowchart describing a flow of the processing of the camera calibration and the three-dimensional reconstruction in the present embodiment. The multiple cameras 1701 installed in the stadium are assumed to constantly capture the images of the contents of the game while oscillating by detecting the soccer ball and tracking the ball position constantly.

In S1801, the CPU 301 instructs the multiple cameras 1701 illustrated in FIG. 17 to start the image capturing while providing a predetermined time difference to increase an image capturing resolution in the temporal direction. Each of the multiple cameras starts the image capturing at image capturing start times different by the predetermined time difference. The predetermined time difference is, for example, a time less than a time of one frame (1/M_{f}). Assuming that the predetermined time difference is T_{d}, for example, the time difference T_{d} is determined based on Mathematical Expression 20.

$${T}_{d} = 1. / ( {M}_{f} \times N ) \qquad [ Mathematical Expression 20 ]$$

N is the number of the multiple cameras 1701 capturing the images of the stadium, and M_{f} (fps) is an image capturing frame rate of the N cameras.

In S1802, the CPU 301 determines the scene of the three-dimensional reconstruction target. For example, an automatic instruction or an instruction determined by human is received and the space as the three-dimensional reconstruction target is determined from the captured images of the cameras 1701 capturing the images of the stadium in which there is the match as the image capturing target as illustrated in FIG. 17. As a method of automatically selecting the scene as the three-dimensional reconstruction target by the CPU 301, the scene as the three-dimensional reconstruction target is determined by automatically detecting a time at which there is an impact in the contents of the game, which is triggered by a moment at which the ball comes into the goal, a timing at which the voice of the crowd becomes loud, and the like. As a method of selecting a conspicuous scene from a series of scenes, the conspicuous scene may be detected also by an already-existing machine learning method in addition to a rule-based method.

In S1803, the CPU 301 obtains the image sequence that is captured by the multiple cameras 1701 within a target time range from a time that is several seconds to tens of seconds before the time indicating the scene determined in S1802 to the time of the determined scene. In S1803, it is unnecessary to obtain the captured images of the target time range from all the cameras 1701 installed in the stadium. For example, the captured images of the target time range may be obtained from only the camera that captures the images of a whole body of the target person of the three-dimensional reconstruction in all the frames corresponding to the target time range.

S1804 is a step similar to S802 in FIG. 8A of the second embodiment, and the segmentation and the tracking of the region is performed to execute the region detection of each object.

Loop processing from S1805 to S1807 is loop processing similar to that from S803 to S805 in FIG. 8A of the second embodiment. That is, the processing target object is selected from the object in the target time range, and the joint position estimation is executed by using an appropriate model for the processing target object. As a result, the joint position estimation is executed on all the objects in all the frames in the target time range.

In S1808, the camera calibration 1 is executed by a method similar to the method described in S806 in FIG. 8A of the second embodiment. In S1808, the camera parameter is substantially obtained.

In S1809, the calibration 2 is executed. Details of the internal processing in S1809 are processing similar to the method described in the third embodiment or the fourth embodiment. That is, in S1809, the same processing as that in S1311 to S1318 in FIG. 13B is executed.

In S1809, the image sequence of each camera obtained by performing the image capturing in different times is used to perform the three-dimensional reconstruction described in the third embodiment and the fourth embodiment. Therefore, in the present embodiment, it is possible to perform the three-dimensional reconstruction of the human body with movement at a high-speed frame rate that is impossible in the usual image capturing by the small number of cameras. For example, it is assumed that each camera executes the image capturing at 60 fps, and after each camera performs the image capturing by moving the image capturing direction to capture the images of the target person, the image sequences of 20 cameras are utilized for the three-dimensional reconstruction. Since the 20 cameras capture the images with a time difference of one frame at 60 fps, a virtual viewpoint moving image generated from the three-dimensional reconstruction result can be a moving image at 60×20=1200 fps. Therefore, according to the present embodiment, it is possible to record a play scene of an athlete moving around fast on the field at an ultrafast frame rate and to view the scene from a free viewpoint later.

### OTHER EMBODIMENTS

In the above-described embodiment, a case where the images are captured by the fixed camera is expected and described. However, in a case where there are sufficient number of key points obtained from the image capturing target, the limitation to capture the images by the fixed camera is unnecessary. Even in a case where the synchronized image capturing is performed by a handheld camera, it is possible to accurately perform the three-dimensional reconstruction.

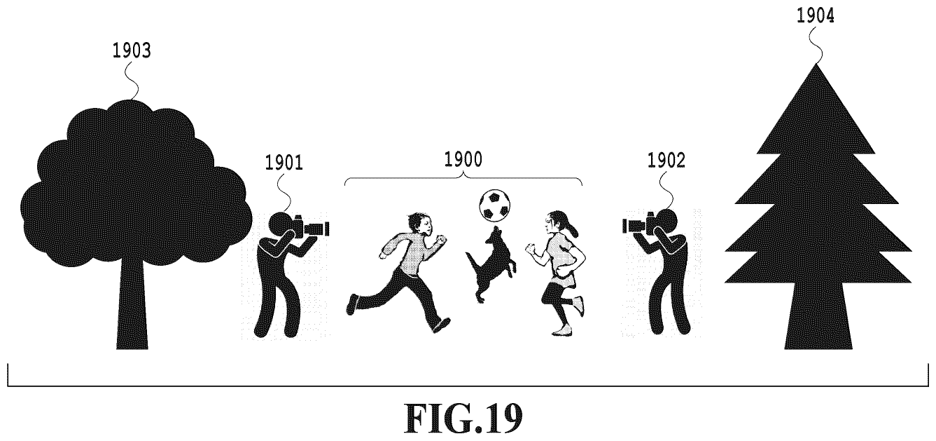

FIG. 19 is a diagram illustrating a situation in which handheld cameras 1901 and 1902 capture the images of a target 1900 of the three-dimensional reconstruction. In this case, the captured images obtained by the image capturing by the handheld cameras 1901 and 1902 may include an object such as backgrounds 1903 and 1904 in addition to the target people 1900 of the three-dimensional reconstruction. In this case, with use of a still point in the scene such as the backgrounds 1903 and 1904, it is easy to estimate the position and the orientation of each handheld camera every time in the camera coordinate system using the Structure from Motion (SfM) described in S. Ullman, The interpretation of structure from motion. Proceedings of the Royal Society of London. (Non-Patent Literature 10).

Also in a case where the three-dimensional reconstruction is performed on also the backgrounds 1903 and 1904, it is easy to estimate the position and the orientation of the handheld camera by using the backgrounds 1903 and 1904. Therefore, the above-described embodiments described as a method executed in a case of the fixed camera can be all implemented as an embodiment of the handheld cameras.

According to the technique of the present disclosure, it is possible to reduce the labor in a case of performing camera calibration to obtain a three-dimensional reconstruction result of an object.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-111288, filed Jul. 10, 2024 and Japanese Patent Application No. 2025-014953 filed Jan. 31, 2025, which are hereby incorporated by reference herein in their entirety.

What is claimed is:

1. An information processing apparatus comprising:
one or more memories storing instructions; and
one or more processors executing the instructions to:
obtain a captured image obtained by each of a plurality of image capturing apparatuses by capturing an object;
detect a position of a predetermined part in the object from the captured image obtained by each of the plurality of image capturing apparatuses;
estimate a camera parameter indicating a position and an orientation of each of the plurality of image capturing apparatuses by using the detected position of the predetermined part;
update the camera parameter of each of the plurality of image capturing apparatuses by using the estimated camera parameter as an initial value; and
determine the camera parameter of each of the plurality of image capturing apparatuses based on a result of performing three-dimensional reconstruction of the object based on the updated camera parameter.

2. The information processing apparatus according to claim 1, wherein
the result of the three-dimensional reconstruction of the object is a model configured to output an image of the object observed with inputted viewpoint information, and
the camera parameter of each of the plurality of image capturing apparatuses is determined based on a result of comparing the image output from the model by inputting the viewpoint information indicated by the updated camera parameter and the captured image obtained by each of the plurality of image capturing apparatuses.

3. The information processing apparatus according to claim 2, wherein
the updated camera parameter in a case where a value indicating a difference between the output image and the captured image obtained by each of the plurality of image capturing apparatuses is equal to or smaller than a threshold is determined as the camera parameter of each of the plurality of image capturing apparatuses.

4. The information processing apparatus according to claim 2, wherein
the one or more processors execute the instructions to further
perform the three-dimensional reconstruction of the object on each of a plurality of frames obtained by each of the plurality of image capturing apparatuses, and
integrate results of the three-dimensional reconstruction by using the updated camera parameter.

5. The information processing apparatus according to claim 4, wherein
the integration is performed by converting a posture of the object expressed by the results of the three-dimensional reconstruction into a predetermined posture, and
the one or more processors execute the instructions to further
inversely convert the posture of the object expressed by the integrated results of the three-dimensional reconstruction, wherein
the model is a model obtained by the inverse conversion.

6. The information processing apparatus according to claim 1, wherein
the update of the camera parameter of each of the plurality of image capturing apparatuses is performed based on the position of the predetermined part.

7. The information processing apparatus according to claim 6, wherein
the position of the predetermined part in the captured image obtained by each of the plurality of image capturing apparatuses is detected, and
the one or more processors execute the instructions to further
integrate the position of the predetermined part detected from each of the captured image by using the updated camera parameter, wherein,
the update of the camera parameter of each of the plurality of image capturing apparatuses is performed based on a result of comparing the detected position of the predetermined part in the captured image and the integrated position of the predetermined part.

8. The information processing apparatus according to claim 6, wherein
the updated camera parameter in a case where a value indicating an error of the updated camera parameter calculated based on a first value and a second value is equal to or smaller than a threshold is determined as the camera parameter of each of the plurality of image capturing apparatuses,
the first value being a value based on the position of the predetermined part, and
the second value being a value based on the result of the three-dimensional reconstruction of the object.

9. The information processing apparatus according to claim 8, wherein
the first value is a value further based on a likelihood of each position of the predetermined parts detected from the captured image obtained by each of the plurality of image capturing apparatuses.

10. The information processing apparatus according to claim 1, wherein
the estimation of the camera parameter of each of the plurality of image capturing apparatuses is performed without using a position of the predetermined part of which a likelihood is equal to or smaller than a threshold.

11. The information processing apparatus according to claim 2, wherein
the object captured by each of the plurality of image capturing apparatuses is a plurality of objects, and
the one or more processors execute the instructions to further
generate a mask indicating a region of each of the plurality of objects in the captured image that is obtained by tracking each of the plurality of objects in chronological order, wherein
the determination of the camera parameter of each of the plurality of image capturing apparatuses is performed based on a result of comparing the regions of the masks between the regions in the output image and the captured image.

12. The information processing apparatus according to claim 11, wherein
the one or more processors execute the instructions to further
apply an identifier to each of the plurality of objects included in the captured image of each of the plurality of image capturing apparatuses by instance segmentation.

13. The information processing apparatus according to claim 2, wherein
the object captured by each of the plurality of image capturing apparatuses is a plurality of objects,
the model is a model corresponding to each of the plurality of objects, and
the one or more processors execute the instructions to further
display an image of a rendered object selected by a user by using the model of the object selected by the user.

14. The information processing apparatus according to claim 1, wherein
the one or more processors execute the instructions to further
estimate a track indicating transition of the position of the predetermined part for each of the plurality of image capturing apparatuses, wherein
the update of the camera parameter of each of the plurality of image capturing apparatuses is performed such that the estimated tracks of the plurality of image capturing apparatuses match.

15. The information processing apparatus according to claim 14, wherein
the estimation of the track for each of the plurality of image capturing apparatuses is performed by using a track basis vector or a basis function defined in advance.

16. The information processing apparatus according to claim 14, wherein
the track estimated for each of the plurality of image capturing apparatuses is compared for each direction component in a three-dimensional space.

17. The information processing apparatus according to claim 14, wherein
the one or more processors execute the instructions to further
instruct the plurality of image capturing apparatuses to start the image capturing while providing a predetermined time difference less than a time of one frame.

18. The information processing apparatus according to claim 1, wherein
the object is a person or an animal, and
the predetermined part is each joint in the person or the animal.

19. The information processing apparatus according to claim 1, wherein
the object is an object of a non-living material, and
the position of the predetermined part is a position of a center of the object.

20. The information processing apparatus according to claim 1, wherein
the plurality of image capturing apparatuses are two or three image capturing apparatuses.

21. An information processing method, comprising:
obtaining a captured image obtained by each of a plurality of image capturing apparatuses by capturing an object;
detecting a position of a predetermined part in the object from the captured image obtained by each of the plurality of image capturing apparatuses;
estimating a camera parameter indicating a position and an orientation of each of the plurality of image capturing apparatuses by using the detected position of the predetermined part;
updating the camera parameter of each of the plurality of image capturing apparatuses by using the estimated camera parameter as an initial value; and
determining the camera parameter of each of the plurality of image capturing apparatuses based on a result of performing three-dimensional reconstruction of the object based on the updated camera parameter.

22. A non-transitory computer readable storage medium storing a program which causes a computer to perform an information processing method, the information processing method comprising:
obtaining a captured image obtained by each of a plurality of image capturing apparatuses by capturing an object;
detecting a position of a predetermined part in the object from the captured image obtained by each of the plurality of image capturing apparatuses;
estimating a camera parameter indicating a position and an orientation of each of the plurality of image capturing apparatuses by using the detected position of the predetermined part;
updating the camera parameter of each of the plurality of image capturing apparatuses by using the estimated camera parameter as an initial value; and
determining the camera parameter of each of the plurality of image capturing apparatuses based on a result of performing three-dimensional reconstruction of the object based on the updated camera parameter.
